(19) United States
(12) Patent Application Publication
(10) Pub. No.: US 2003/0028380 A1
(43) Pub. Date: Feb. 6, 2003

(54) Speech system

(76) Inventors: Warwick Peter Freeland, Fitzroy (AU); Ian Edward Dixon, Blackburn (AU); Glenn Charles Brien, Beaconsfield (AU)

Correspondence Address: Samuels, Gauthier & Stevens LLP, 225 Franklin Street, Suite 3300, Boston, MA, 02110, US

(21) Appl. No.: 10/211,637

(22) Filed: Aug. 2, 2002

Related U.S. Application Data
(63) Continuation of application No. PCT/AU01/00111, filed on Feb. 2, 2001.

(30) Foreign Application Priority Data
Feb. 2, 2000 (AU) PQ5406
Jul. 13, 2000 (AU) PQ8775

(51) Int. Cl. G10L 13/08

(52) U.S. Cl. 704/260

(57) ABSTRACT

A system for generating an audio message over a communications network that is at least partly in a voice representative of a character generally recognizable to a user. Either a voice message or text based message may be used to construct the audio message. Specific recordings of well known characters is stored in a storage means and background sound effects can be inserted into the audio message which are stored in database. The audio message is constructed by any one of the processing means and transmitted to a recipient for play back on a processing terminal.

### FIELD OF THE INVENTION

The invention relates to generating speech, and relates particularly but not exclusively to systems and methods of generating speech which involve the playback of messages in audio format, especially for entertainment purposes, such as in connection with digital communication systems and information systems, or amusement and novelty toys.

### BACKGROUND OF THE INVENTION

Computer software of increasing sophistication, and hardware of increasing power, has opened up possibilities for enhanced entertainment opportunities on digital platforms. This includes, for example, the Internet accessed through devices such as personal computers or gaming consoles, digital television and radio applications, digital telephony etc.

In particular, there has been a significant growth in the complexity of computer games, as well as increased use of email systems, chat rooms (such as ICQ and others), other instant messaging services (such as SMS) and multi-user domains. In most cases, these types of applications are text-based or at least rely heavily on the use of text. However, to date, these applications have not made significant use of text-to-voice technology to enhance a user's experience of these types of applications, despite the widespread vailability of these technologies.

In applications where computer generated voices have been used, the technology has been used primarily as a carrier for unprocessed voice signals. For example, Internet-based chat rooms (for example, Netmeeting) exist whereby two or more users can communicate in their own voices instead of via typed messages. In applications where text to speech technology has been used (for example, email reading programs), the entertainment value of the voice has been low due to the provision of usually only one voice, or a small number of generic voices (for example US English male).

Talking toys have a certain entertainment value, but existing toys are usually restricted to a fixed sequence or a random selection of pre-recorded messages. In some toys, the sequence of available messages can be determined by a selection from a set of supplied messages. In other cases, the user has the opportunity of making a recording of their own voice, such as with a conventional cassette recorder or karioke machine, for use with the toy.

Users of such talking toys can quickly tire of their toy's novelty value as the existing options and their various combinations hold limited entertainment possibilities, as there are only moderate amusement options which are available to the user.

It is an object of the invention to at least attempt to address these and other limitations of the prior art. More particularly, it is an object of the invention to address these and other deficiencies in connection with the amusement value associated with text and audio messages especially messages generated or processed by digital communications or infomation systems.

It is an object of the invention to address these and other deficiencies in connection with the amusement value associated with audio messages for entertainment purposes in connection with talking toys.

### SUMMARY OF THE INVENTION

The inventive concept resides in a recogniton that text can desirably be converted into a voice representative of a particular character, such as a well known entertainment personality or fictional character. This concept has various inventive applications in a variety of contexts, including use in connection with, for example, text-based messages. As an example, text-based communications such as email or chat-based systems such as IRC or ICQ can be enhanced in accordance with the inventive concept by using software applications or functionality that allows for playback of text-based messages in the voice of a particular character. As a further example, it is possible to provide, in accordance with the inventive concept, a physical toy which can be configured by a user to play one or more voice messages in the voice of a character or personality represented by the stylistic design of the toy (for example, Elvis Presley or Homer Simpson). In either case, the text-based message can be constructed by the user by typing or otherwise constructing the text message representative of the desired audio message.

According to a first aspect of the invention there is provided a method of generating an audio message, including:

providing a text-based message; and

generating said audio message based on said text-based message;

wherein said audio message is at least partly in a voice which is representative of a character generally recognizable to a user.

According to a second aspect of the invention there is provided a system for generating an audio message comprising:

means for providing a text-based message;

means for generating said audio message based on said text-based message;

wherein said audio message is at leat partly in a voice which is repesentative of a character generally recognisable to a user.

According to a third aspect of the invention there is provided a system for generating an audio message using a communications network, said system comprising:

means for providing a text-based message linked to said communications network;

means for generating said audio message based on said text-based message;

wherein said audio message is at least partly in a voice which is representative of a character generally recognisable to a user.

Preferably, the character in whose voice the audio message is generated is selected from a predefined list of characters which are generally recognisable to a user.

Preferably, the audio message is generated based on the text-based message using a textual database which indexes speech units (words, phrases and sub-word phrases) with corresponding audio recordings representing those speech units. Preferably, the audio message is generated by concatenating together one or more audio recordings of speech units, the sequence of the concatenated audio recordings being determined with reference to indexed speech units associated with one or more of the audio recordings in the sequence.

Preferably, words in a text-based message which do not have corresponding audio recordings of suitable speech units are substituted with substitute words which do have corresponding audio recordings. Preferably, the substituted word has a closely similar grammatical meaning to the original word, in the context of the text-based message.

Preferably, a thesaurus which indexes a large number of words with alternative words is used to achieve this substitution. Preferably, the original word is substituted with a replacement supported word which has suitably associated audio recordings. Preferably, the thesaurus can be iteratively searched for alternative words to eventually find a supported word having suitably associated audio recordings. Preferably, use of the thesaurus may be extended to include grammatical-based processing of text-based messages, or dictionary-based processing of text-based messages. Alternatively, unsupported words can be synthesised by reproducing a sequence of audio recordings of suitable atomic speech elements (for example, diphones) and applying signal processing to this sequence to enhance its naturalness.

Preferably, the supported words having associated suitable audio recordings are a collection of commonly used words in a particular language that are generally adequate for general communication. Preferably, the textual database further indexes syllables and phrases. Preferably, the phrases are phrases which are commonly used in the target language, or are phrases characteristic of the character. In some cases, it is desirable that the phrases include phrases that are purposefully or intentionally out of character.

Preferably, the generation of audio messages optionally involves a preliminary step of converting the provided text-based message into a corresponding text-based message which is instead used as the basis for generating the audio message.

Preferably, conversion from an original text-based message to a corresponding text-based message substitutes the original text-based message with a corresponding text-based message which is an idiomatic representation of the original text-based message.

Preferably, in some embodiments, the corresponding text-based message is in an idiom which is attributable to, associated with, or at least compatible with the character.

Preferably, in other embodinents, the corresponding text-based message is in an idiom which is intentionally incompatible with the character, or attributable to, or associated with a different character which is generally recognisable by a user.

Preferably, if the text-based massage involves a narrative in which multiple narrative characters appear, the audio message can be generated in respective multiple voices, each representative of a different character which is generally recognisable to a user.

Preferably, only certain words or word strings in an original text-based message are converated to a corresponding text-based message which is an idiomatic representation of the original text-based message.

Preferably, there can be provided conversion from an original text-based message to a corresponding text-based message which involves a translation between two established human languages, such as French and English. Of course translation may involve either a source or a target language which is a constructed or devised language which is attributable to, associated with, or at least compatible with the character (for example, the Pokemon language). Translation between languages may be alternative or additional to substitution to an idiom of the character.

Preferably, the text-based message is provided by a user. Preferably, the text is entered by the user as a sequence of codes using, for example, an alpha-numeric keyboard.

Preferably, the user provded text-based message can include words or other text-based elements which are selected from a predetermined list of particular text-based elements. This list of text-based elements includes, for example, words as well as common phrases or expressions. One or more of these words, phrases or expressions may be specific to a particular character. The text-based elements can include vocal expressions that are attributable to, associated with, or at least compatible with the character.

Preferably, text-based elements are represented in a text-based message with specific codes representative of the respective text-based element. Preferably, this is achieved using a preliminary escape code sequence followed by the appropriate code for the text-based element. Text-based elements can be inserted by users, or inserted automatically to punctuate, for example, sentences in a text-based message. Alternatively, generation of an audio message can include the random insertion of particular vocal expressions between certain predetermined audio recordings from which the audio message is composed.

Preferably, this coded sequence can also be used to express emotions, mark changes in the character identification, insert background sounds and canned expressions in the text-based message. Preferably, this coded sequence is based on HTML or XML.

Preferably, the textual database omits certain words which are not considered suitable, so that the generated audio messages can be censored to a certain extent.

Preferably, the text-based message can be generated from an audio message by using voice recognition technology, and subsequently used as the basis for the generation of an audio message in a voice representative of a generally recognisable character.

Preferably, a user can apply one or more audio effects to the audio message. These effects, for example, can be used to change the sound chacteristics of the audio message so that it sounds, for example, as if the character is underwater, or has a cold etc. Or optionally, the characteristics of the speech signal (for example, the “FO” signal, or phonetic and prosodic models) may be deliberately modified or replaced to substantially modify the characteristics of the voice. An example, may be a lawn mower speaking in a voice recognisable as Elvis Presley's. Preferably, the text-based message is represented in a form able to be used by digital computers, such as ASCII (American Standard Code for Information Interchange).

Preferably, the inventive methods described above are performed using a computing device having installed therein a suitable operatng system able to execute software capable of effecting these methods. Preferably, the methods are performed using a user's local computing device, or performed using a computing device with which a user can remotely communicate with through a network. Preferably, a number of users provide text-based messages to a central computing device connected on the Internet and accessible using a World Wide Web (WWW) site, and receive via the Internet an audio message. The audio message can be received as either a file in a standard audio file format which is, for example, transferred across the Internet using the FTP or HTTP protocols or as an attachment to an email message. Alternatively, the audio message may be provided as a streaming audio broadcast to one or more users.

In embodiments in which an audio message is generated by means of a computing device, the option is preferably provided to generate an accompanying animated image which corresponds with the audio message. Preferably, this option is available where an audio message is generated by a user's local computing device. Preferably, the audio message and the animation are provided in a single audio/visual computer interpretable file format, such as Microsoft AVI format, or Apple QuickTime format. Preferably, the animation is a visual representation of the character which “speaks” the audio message, and the character moves in accordance with the audio message. For example, the animated character preferably moves its mouth and/or other facial or bodily features in response to the audio message. Preferably, movement of the animated character is synchronised with predetermined audio or speech events in the audio message. This might include, for example, the start and end of words, or the use of certain key phrases, or signature sounds.

Embodiments of the invention are preferably facilitated using a network which allows for communication of text-based messages and/or audio messages between users. Preferably, a network server can be used to distribute one or more audio messages generated in accordance with embodiments of the invention.

Preferably, the inventive methods are used in conjunction with text-based communications or messaging systems such as email (electronic mail) or electronic greeting cards or chat-based systems such as IRC (Internet relay chat) or ICQ (or other IP-to-IP messaging systems). In these cases, the text-based message is provided, or at least derived from the text of the text message of the email message, electronic greeting card or chat line.

Preferably, when said inventive methods are used in conjunction with email or similar asynchronous messaging systems, audio messages may be embedded wholly within the transmitted message. Alternatively, a hyperlink or other suitable reference to the audio message may be provided within email message. Regardless of whether the audio message is provided in total or by reference, the audio message may be played immediately or stored on a storage medium for later replay. Audio messages may be broadcast to multiple recipients, or forwarded between recipient as required. Messages may be automatically transmitted to certain recipients based on predetermined rules, for example, a birthday message on the recipient's message. In other embodiments, transmission of an audio message may be replaced by transmission of a text message which is converted to an audio message at the recipient's computing terminal. The voice in which the transmitted text message is to be read is preferably able to be specified by the sender. Preferably, transmissions of the above kind are presented as a digital greeting message.

Preferably, when said inventive methods are used in conjunction with chat rooms or similar synchronous messaging systems, incoming and/or outgoing messages are converted to audio messages in the voice of a partoular oharacter. Messages exchanged in chat rooms can be converted directly from text provided by users, which may be optionally derived through speech recognition means processing the speaking voices of chat room users. Preferably, each chat room user is able to specify at least to a default level the particular character's voice in which their messages are provided. In some embodiments, it is desirable that each user is able to assign particular character's voices to other chat room users. In other embodiments, particular chat room users may be automatically assigned partcular character's voices. In this case, particular chat rooms would be notionally populated by characters having a particular theme (for example, a chat room populated by famous American political figures).

Preferably, the inventive methods are used in conjunction with graphical user interfaces such as provided by computing operating systems, or paricular applications such as the World Wide Web. Preferably, certain embodiments provide a navigation agent which uses text-based messages spoken in the voice of a recognisable character to assist the user in navigating the graphical interface user.

Preferably, the methods are also able to be extended for use with other messaging systems, such as voice mail. This may involve, for example, generation of a text representation of a voice message left on a voice mail service. This can be used to provide or derive a text-based message on which a generated audio message can be based.

Preferably, the methods can be applied in the context of recording a greeting message provided on an answering machine or service. A user can have a computing device configured, either directly or through a telephone network, the answering machine or service to use an audio message generated in accordance with the inventive method.

Preferably, a central computing device on the Internet can be accessed by users to communicate through the telephone network with the answering machine or service, so that the answering machine or service stores a record of a generated audio message. This audio message may be based on a text-based message provided to the central computing device by the user, or deduced through speech recognition of the existing greeting message used by the answering machine or service.

Preferably, the language in which the text message is entered and the language of the spoken voices is a variation of standard English, such as Americanised English.

Preferably, the prosidy and accent (pitch and speaking speed) of the message and optionally, the selection of character is dependent upon such factors as the experience level of the user, the native accent of the user, the need (or otherwise) for speedy response, how busy the network is and the location of the user.

Preferably, “voice fonts” for recognisable characters can be developed by recording that character's voice for use in a text-to-speech system, using suitable tehniques and equipment.

Preferably, many users can interact with systems provided in accordance with embodiments. Preferably, a database of messages is provided that allows a user to recall or resend recent text to speech messages.

Preferably, the inventive methods are used to supply a regularly updated database of audio based jokes, wise-cracks, stories, advertisements and song extracts in the voice of a known character, based on conversion from a mostly textual version of the joke, wise-crack, story, advertisement or song extract to audio format. Preferably, said jokes, wise-cracks, stories, advertisements and song extracts are delivered to one or more users by means of a computer network such as the Internet.

Preferably, prosidy can be deduced from the grammatical stucture of the text-based message. Alternatively, prosidy can be trained by anlysing an audio waveform of the user's own voice as he/she reads the entered text with all of the inflection, speed and emotion cues built into the recording of the user's own voice, this prosidic model then being used to guide the text to speech conversion process. Alternatively, prosidy may be trained by extracting this information from the user's own voice in a speech to speech system. In each of these prosidy generation methods, prosidy may be enhanced by including emotional markups/cues in the text-based message. Preferably, the corpus (textual script of recordings that make up the recorded speech database) may be marked up (for example, with escape codes, HTML, SABLE, XML, etc.) to include descriptions of the emotional expression used during the recording of the corpus.

Preferably, a character voice TTS generated audio format file can be protected from multiple or unauthorised use by encryption or with time delay technology, preferably by the use of an encoder and decoder program.

Preferably, the inventive methods can be used to narrate a story on the user's computer or toy. The character voices that play any or each of the characters and/or the narrator of the story can preferably be altered by the user. Each segment of the story may be constructed from sound segments of recorded words, phrases and sentences of the desired characters or optionally partially or wholly constructed using the chat TTS system.

Preferably, the inventive methods can be used to provide navigational aids for media systems such as the Web. Preferably, Web sites can include the use of a famous character's voice to assist a user in navigating a site. A character's voice can also be used to present information otherwise included in the site, or provide a commentary complementary to the information provided by the Web site. The characters voice may also function as an interactive agent of whom the user may present queries. In other embodiments, the Web site may present a dialogue between different characters as part of the user's experience. The dialogue may be automatically generated, or dictated by feedback provided by the user.

Preferably, telephony-based navigation systems, or such as Interactive Voice Response (TVR) systems can provide recognisable voices based on text provided to the system. Similarly, narrowband navigation systems such as provided by the Wireless Application Protocol (WAP) can alternatively use recognisable voices instead of text to a user of such a system.

Preferably, embodiments can be used in conjunction with digital broadcast systems such as, for example, digital radio and digital television, to convert broadcast text messages to audio messages read in a voice of a recognisable character.

Preferably, embodiments may be used in conjunction with simulated or virtual worlds so that, for example, text messages are spoken in a recognisable voice by avatars or other represented entities within such environments. Preferably, avatars in such environments have a visual representation which corresponds with that of the recognisable character in whose voice text messages are rendered in the environment.

Preferably, text messages used in relation to embodiments of the invention may be marked using tags or other notation in a markup language to facilitate conversion of the text message to that of a famous character's voice. Such a defined language may provide the ability to specify between the voices of different famous characters, and different emotions in which the text is to be reproduced in audio form. Character-specific features may be used to provide the ability to specify more precisely how a particular text message is rendered in audio form. Preferably, automated tools are provided in computing environments to provide these functions.

Preferably, embodiments of the invention can used to provide audio messages that are synchronised with visual images of the character in whose voice the audio message is provided. In this respect, a digital representation of the character may be provided, and their represented facial expressions reflect the sequence of words, expressions and other aurel elements “spoken” by that character.

Preferably, embodiments may be used to provide a personalised message to a user by way of reference, for example, to a Web site. Preferably, the personalised message is provided to the user in the context of providing a gift to that user. Preferably, the message relates to a greeting made from one person to another, and is rendered in a famous character's voice. The greeting message may represent a dialogue between different famous characters which refers to a specific type of greeting occasion such as, for example, a birthday.

Preferably, in the described embodiments of the invention, generally use of one voice is described. However, embodiments are in general equally suited to the use of multiple voices of different respective recognisable characters.

Preferably, embodiments can be used in a wide variety of different applications and contexts than those specifically referred to above. For example, virtual news readers, audio comic strips, multimedia presentations, graphic user interface prompts etc can incorporate text to speech functionality in accordance with embodiments of the invention.

Preferably, the above methods can be used in conjunction with a toy which can be connected with a computing device, either directly or through a network. Preferably, when a toy is used in conjunction with a computing device, the toy and the computing device can be used to share, as appropriate, the functionality required to achieve the inventive methods described above.

Accordingly, the invention further includes coded instructions interpretable by a computing device for performing the inventive methods described above. The invention also includes a computer program product provided on a medium, the medium recording coded instructions interpretable by a computing device which is adapted to consequently perform the inventive methods described above. The invention further includes distributing or providing for distribution through a network coded instructions interpretable by a computing device for performing in accordance with the instructions the inventive methods described above. The invention also includes a computing device performing or adapted to perform the inventive methods described above.

According to a fourth aspect of the invention there is provided a toy comprising:

speaker means for playback of an audio signal;

memory means to store a text-bassd message; and

controller means operatively connecting said memory means and said speaker means for generating an audio signal for playback by said speaker means;

wherein said controller means, in use, generates an audio message which is at least partly in a voice representative of a character generally rocognisable to a user.

According to a fifth aspect of the present invention there is provided a toy comprising:

speaker means for playback of an audio signal;

memory means to store an audio message; and

controller means operatively connecting said memory means and said speaker means for generating said audio signal for playback by said speaker means;

wherein said controller means, in use, generates said audio message which is at least partly in a voice representative of a character generally recognisable to a user.

Preferably, the toy is adapted to perform, as applicable, one or more of the preferred methods described above.

Preferably, the controller means is operatively connected with a connection means which allows the toy to communicate with a computing device. Preferably, the computing device is a computer which is connected with the toy by a cable via the connection means. Alternatively, the connection means may be adapted to provide a wireless connection, either directly to a computer or through a network such as the Internet.

Preferably, the connetion means allows text-based messages (such as email) or recorded audio messages to be provided to the toy for playback through the speaker means. Alternatively, the connection means allows an audio signal to be provided directly to the speaker means for playback of audio message.

Preferably, the toy has the form of the character. Preferably, the toy is adapted to move its mouth and/or other facial or bodily features in response to the audio message. Preferably, movement of the toy is synchronised with predetermined speech events of the audio message. This might include, for example, the start and end of words, or the use of certain key phrases, or signature sounds.

Preferably, the toy is an electronic hand-held toy having a microprocessor-based controller means, and a non-volatile memory means. Preferably, the toy includes functionality to allow for recording and playback of audio. Preferably, audio recorded by the toy can be converted to a text-based message which is then used to generate an audio message based on the text-based message, which is spoken in a voice of a generally recognisable character. Preferred features of the inventive method described above analogously apply where appropriate in relation to the inventive toy.

Alternatively, when the toy includes a connection means, an audio message can be provided directly to the toy using the connection means for playback of the audio message through the speaker means. In this case, the text-based message can be converted to an audio message by a computing device with which the toy is connected, either directly or through a network such as the Internet. The audio message provided to the toy is stored in the memory means and reproduced by the speaker means. The advantage of this configuration is that it requires less processing power of the controller means and less storage capacity of the memory means of the toy. It also provides greater flexibility in how the text-based message can be converted to an audio message as, for example, if the text to audio processing is performed on a central computing device connected on the Internet, software executing on the central computing device can be modified as required to provide enhanced text to audio functionality.

According to a sixth aspect of the invention there is provided a system for generating an audio message which is at least partly in a voice representative of a character generally recognisable to a user, said system comprising:

means for transmitting a message request over a communications network;

message processing means for receiving said message request;

wherein said processing means processes said message request and constructs said audio message that is at least partly in a voice representative of a character generally recognisable to a user and forwarding the constructed audio message over said communications network to one or more recipients.

According to a seventh aspect of the present invention there is provided a method for generating an audio message which is at least partly in a voice representative of a character generally recognisable to a user; said method comprising the following steps:

transmitting a message request over a communications network;

processing said message request and constructing said audio message in at least partly a voice representative of a character generally recognisable to a user; and

forwarding the constructed audio message over said communication network to one or more recipients.

According to an eighth aspect of the invention there is provided a method of generating an audio message, comprising the steps of:

providing a request to generate said audio message in a predetermined format;

generating said audio message based on said request;

wherein said audio message is at least partly in a voice which is representative of a character generally recognisable to a user.

### BRIEF DESCRIPTION OF THE DRAWINGS

FIG. 1 is a schematic block diagram showing a system used to construct and deliver an audio message according to a first embodiment;

FIG. 2 is a flow diagram showing the steps involved in converting text or speech input by a sender in a first language in a first language into a second language;

FIG. 3 is a schematic block diagram of a system used to construct and deliver an audio message according to a further embodiment;

FIG. 4 shows examples of text appearing on screens of a processing terminal used by a sender;

FIG. 5 is a flow diagram showing a generally process steps used by the present invention;

FIG. 6 is an example of a template used by a sender in order to construct an audio message in the voice of a famous person;

FIG. 7 is a schematic diagram showing examples of drop down menus used to construct an audio message;

FIG. 8 is a flow diagram showing processes involved for when a word or phrase is not to be spoken by a selected famous character;

FIG. 9 is a flow diagram showing process steps used in accordance with a natural language conversion system;

FIG. 10 is a flow diagram showing process steps used by a user to construct a message using a speech interface;

FIG. 11 is a schematic diagram of a web page accessed by a user wishing to construct a message to be received by a recipient;

FIG. 12 is a schematic diagram showing a toy connectable to a computing processing means that may store and play back messages recorded in a voice of a famous character.

### DETAILED DESCRIPTION OF PREFERRED EMBODIMENTS

Various embodiments are described below in detail. The system by which text is converted to speech is referred to as the TTS system. ln certain embodiments, the user can enter text or retrieve text which represents the written language statements of the audible words or language constructs that the user desires to be spoken. The TTS system processes this text-based message and performs a conversion operation upon the message to generate an audio message. The audio message is in the voice of a character that is recognisable to most users, such as a popular cartoon character (for example, Homer Simpson) or real-life personality (for example, Elvis Presley). Alternatively “stereotypical” characters may be used, such as a “rap artist” (e.g. Puffy), whereby the message is in a voice typical of how a rap artist speaks. Or the voice could be a “granny” (for grandmother) “spaced” (for a spaced-out drugged person) or in a “sexy” voice. Many other stereotypical character voices can be used.

The text to audio conversion operation converts the text message to an audio format message representing the message, spoken in one of several well known character voices (for example, Elvis Presley or Daffy Duck) or an imrpersonation of the character's voice. In embodiments that are implemented in software, the chosen character is selected from a database of supported characters, either automatically or by the user. The conversion process of generating an audio message is described in greater detail below under the heading “TTS System.” In the toy embodiment, the voice is desirably compatible with the visual design of the toy and/or the toy's accessories such as clip-on components. The user can connect the toy to a compatible computer using the connection means of the toy. The software preferably downloads the audio format message to the user's compatible computer which in turn transfers the audio format message to non-volatile memory on the toy via the connecting means. The user can unplug the toy from the compatible computer. The user then operates the controlling means on the toy to play and replay the audio format message.

Software can download the audio format message to the user's compatible computer via the Internet and the connected modem. The audio format message is in a standard computer audio format (for example, Microsoft's WAV or RealAudio's AU formats), and the message can be replayed through the compatible computer's speakers using a suitable audio replay software package (for example, Microsoft Sound Recorder).

TTS system

In the preferred embodiments, a hybrid TTS system is used to perform conversion of a text-based message to an audio format message. A hybrid TTS system (for example, Festival) combines the best features of limited domain slot and filler TTS systems, unit selection TTS systems and synthesised TTS system. Limited domain slot and filler TTS systems give excellent voice quality in limited domains, unit selection TTS systems give very good voice quality in broad domains, but require large sets of recorded voice data. Synthesized TTS systems provide very broad to unlimited text domain coverage from a small set of recorded speech elements (for example, diphones), however suffer from lower voice quality. A unit selection TTS system is an enhanced form of Concatenative TTS System, whereby the system can select large (or small) sections of recorded speech that best match the desired phonetic and prosodic structure of the text.

It should be appreciated, however, that concatenative or synthesised TTS Sytems can be used instead of a hybrid TTS system. In the preferred embodiments, the activation of each component of the hybrid TTS system is optimised to give the best voice quality possible for each text message conversion.

Concatenative TTS system

In the preferred embodiments, a concatenative TTS system may alternatively be used to perform conversion of a text-based message to an audio format message instead of a hybrid TTS system. In is process the text message is decoded into unique indexes into a database, herein called a “supported word-base”, for each unique word or phrase contained within the message. The character TTS system then preferably uses these indices to extract audio format samples for each unique word or phrase from the supported word-base and concatenates (joins) these samples together into a single audio format message which represents the complete spoken message, whereby said audio format samples have been pre-recorded in the selected character's voice or am impersonation of the selected character's voice.

The character TTS system software may optionally perform processing operations upon the individual audio format samples or the sequence of audio format samples to increase the intelligibility and naturalness of the resultant audio format message. Preferably, the processing may include prosody adjustment algorithms to improve the rate at which the spoken audio format samples are recorded in the final audio format message and the gaps between these samples such that the complete audio format message sounds as natural as possible. Other optional processing steps include intonation algorithms which analyse the grammatical structure of the text message and continuously vary the pitch of the spoken message and optionally, the prosody, to closely match natural speech.

Synthesised TTS system

Whilst a hybrid TTS system is desirable, a synthesised TTS system can also be used.

A synthesised TTS system uses advanced text, phonetic and grammatical processing to enhance the range of phrases and sentences understood by the TTS system and relies to a lesser extent on pre-recorded words and phrases than does the concatenative TTS system but rather, synthesises the audio output based on a stored theoretical model of the selected character's voice and individual phoneme or diphone recordings.

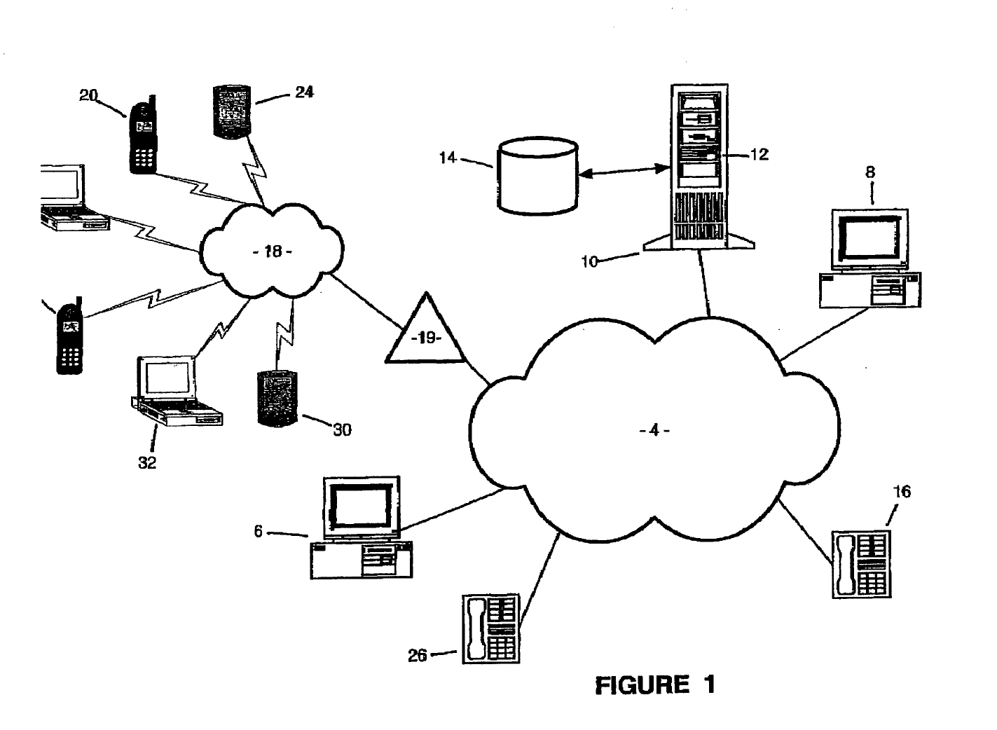

Shown in FIG. 1 is a system used for generating audio messages. The system generally includes a communications network 4 which may be either the Internet or a PSTN for example to which is linked a computing processing means 6 used by a message sender, a computing processing means 8 used by a recipient of a message and a server means 10 that may have its own storage means 12 or be associated with a further database 14. Generally when a user wishes to send a message that may include background effects or be in a voice of a well known character they would type in their message on computing processing means 6 which is then transmitted to server means 10 that may have a text to speech conversion unit incorporated therein to convert the text into speech and substituting a portion of or all of the message with speech elements that are recorded in the voice of a chosen well known character. These recordings are stored in either database 14 or storage means 12 together with background effects for insertion into the message. Thereafter the audio message is then transmitted to the recipient either by email over communications network 4 to the terminal 8 or alternatively as an audio message to telephone terminal 16. Alternatively the audio message may be transmitted over a mobile network 18 to a recipient mobile telephone 20 or mobile computing processing means 22 or personal digital assistant 24 which may then be played back as an audio file. The network 18 is linked to the communications network 4 through a gateway (e.g. SMS, WAP) 19. Alternatively the sender of the message or greeting may use telephone terminal 26 to deliver their message to the server means 10 which has a speech recognition engine for converting the audio message into a text message which is then converted back into an audio message in the voice of a famous character with or without background effects and with or without prosidy. It is then sent to either terminal 8 or 16 or one of the mobile terminals 20, 22 or 24 for the recipient. Alternatively the sender of the message may construct a message using SMS on their mobile phone 28 or personal digital assistant 30 or computing processing terminal 32 which are linked to the mobile network 18. Alternatively an audio message may be constructed using a mobile terminal 28 and all of the message is sent to the server means 10 for further processing as outlined above.

Basic text verification system (TVS) description

A feature of certain embodiments is the ability to verify that the words or phrases within the text message are capable of conversion to audio voice form within the character TTS system. This is particularly important for embodiments which use a concatenative TTS system, as concatenative TTS systems may generally only convert text to audio format messages for the subset of words that coincide with the database of audio recorded spoken words. That is, a concatenative TTS system has a limited vocabulary.

Preferred embodiments include a Text Verification System (TVS) which processes the text message when it is complete or “on the fly” (word by word). In this way, the TVS checks each word or phrase in the text message for audio recordings of suitable speech units. If there is a matching speech unit, the word is referred to as a supported word, otherwise it is referred to as an unsupported word. The TVS preferably substitutes each unsupported word or phrase with a supported word of similar meaning.

This can be performed automatically so that almost any text message is converted into an audio format message in which all of the words spoken in the audio format message have the same grammatical meaning as the words in the text message.

Digital thesaurus based text verification system (TVS)

Another feature relates to the mechanism used in the optional Text Verification System (TVS). In preferred embodiments, this function is performed by a thesaurus-based TVS, however, it should be noted that other forms of TVS (for example, dictionary-based, supported word-base based, grammatical-processing based) can also be used.

Thesaurus-based TVS preferably uses one or more large digital thesauruses, which include indexing and searching features. The thesaurus-based TVS preferably creates an index into the word-base of a selected digital thesaurus for each unsupported word in the text message. The TVS then preferably indexes the thesaurus to find the unsupported word. The TVS then creates an internal list of equivalent words based on the synonymous words referenced by the thesaurus entry for the unsupported word. The TVS then preferably utilises software adapted to work with or included in the character TTS system. The software is used to check if any of the words in the internal list are supported words. If one or more words in the internal list are supported words, the TVS then preferably converts the unsupported word in the text message to one of said supported words or alternatively, displays all of the supported words contained in the internal list to the user for selection by the user.

If none of the words in the internal list are supported words, the TVS then uses each word in the internal list as an index back into said digital thesaurus and repeats the search preferably, producing a second larger internal list of words with similar meaning to each of the words in the original internal list. In this way, the TVS continues to expand its search for supported words until either a supported word is found or some selectable search depth is exceeded. If the predetermined search depth is exceeded, the TVS preferably reports to the user that no equivalent word could be found and the user can be prompted to enter a new word in place of the unsupported word.

It should be noted that correct spelling of each word in the text message, prior to processing by the TVS is important and a spelling check and correct function is optionally included as part of the software or preferably as part of the TVS.

Optionally, the TVS may provide visual feedback to the user which highlights, such as by way of colour coding or other highlighting means, the unsupported words in the text message. Supported word options can be displayed to the user for each unsupported word, preferably by way of a drop down list of supported words, optionally highlighting the supported word that the TVS determines to be the best fit for the unsupported word that it intends to replace.

The user can then select a supported word from each of said drop down lists, thereafter instructing the software to complete the audio conversion process using the user's selections for each unsupported word in the original text message.

It should be noted that improved results for the TVS and chat TTS system can be obtained by providing some grammatical processing of sentences and phrases contained in the text message and the digital thesaurus being extended to include common phrases and word groups (for example, “will go”, “to do”, “to be”) and said supported word-base to include such phrases and word groups, herein called supported phrases.

In this case, the TVS and character TTS system would first attempt to find supported or synonymous phrases before performing searches at the word level. That is, supported words, and their use within the context of a supported word-base, can be extended to include phrases.

TVS enhancements

A further feature provides for multiple thesaurus within the TVS. The thesauruses are independently configured to bias searches towards specific words and phrases that produce one or a plurality a specific effects. The character TTS system may in this embodiment, be optionally configured such that supported words within the word-base are deliberately not matched bit rather sent to the TVS for matching against equivalent supported words. An example effect would be “Hip-hop” whereby when a user entered a text message as follows, “Hello my friend. How are you?”, the Hip-hop effect method of the TVS would convert the text message to “Hey dude. How's it hanging man?”, thereafter, the character TTS system would convert said second text message to a spoken equivalent audio format message.

Additional effects can be achieved using the thesaurus-based TVS by adding different selectable thesauruses, whereby each thesaurus contains words and phrases specific to a particular desired effect (for example, Rap, Net Talk etc.).

Preferred language

The language in which the text message is entered and the language of the spoken voices is a variation of standard English, such as Americanised English. Of course, any other languages can be used.

Language conversion

A language conversion system (LCS) can be used with certain embodiments to convert a text message in one language to a text message in another language. The character TTS system is consequently adapted to include a supported word-base of voice samples in one or more characters, speaking in the target language.

Thus a user can convert a message from one language into another language, wherein the message is subsequently converted to an audio format message, representative of the voice of a character or personality, such as one well known in the culture of the second target language.

Furthermore, the Speech Recognition (SR) system described elsewhere in this specification can be used in conjunction with this feature to provide a front end for the user that allows construction of the text message in the first language by recording and decoding of the user's message in the first language by way of the SR system, subsequent text message then being processed by the LCS, character TTS system and optionally the TVS as described above. This allows a user to speak a message in his own voice and have said message converted to an equivalent message in another language, whereby the foreign language message is spoken by a well known character or personality (for example, in the case of French, the French actor Gerard Depardieu). Of course, this foreign language ability can be utilised with email or other messaging system to send and receive foreign message emails in the context of the described system.

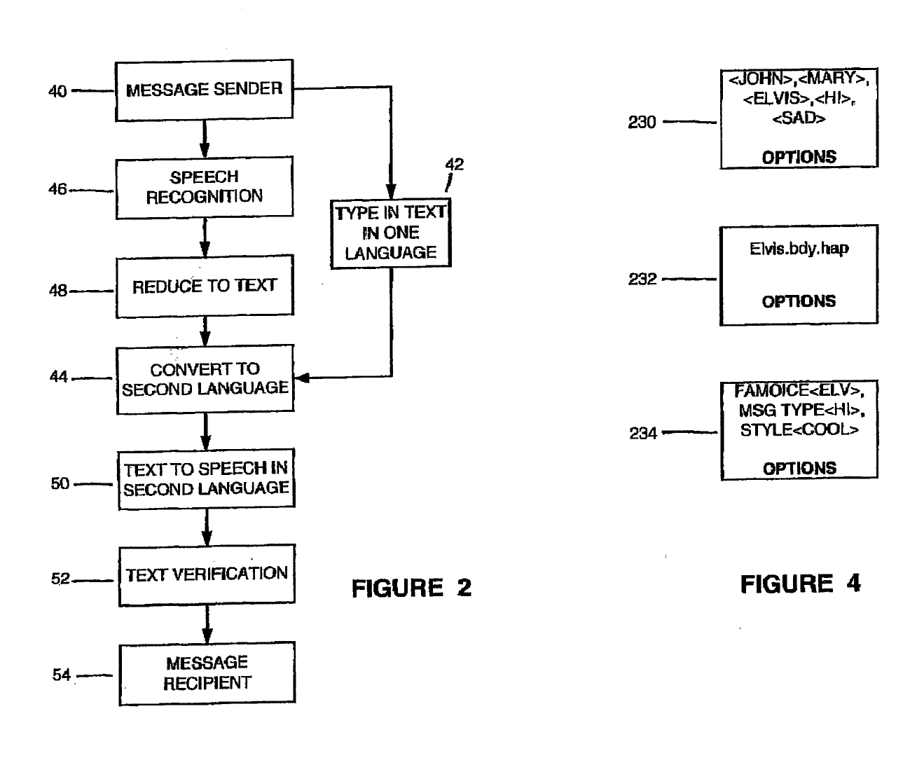

Thus shown in FIG. 2 is an example of steps that are taken in such language conversion. Specifically when a user wishes to construct a message at step 40 they can either type in the text of the message in their native language at step 42 which is then forwarded to a language conversion program which may reside on the server means 10 whereby that program would convert the language of the inputted text into a second language which typically would be the native language of the recipient at step 44. Alternatively the message sender may use a terminal 26 to dial up the server 10 whereby they input a message orally which is recognised by a speech recognition unit 46 and reduced to a text version at step 48 whereby it is then converted into the language of the recipient at step 44. Both streams then feed into step 50 whereby the text in the second language of the recipient is converted to speech which may include background sound effects or be in the voice of a well known character, typically native to the country or language spoken by the recipient and may then optionally go through the TVS unit at step 52 and be received by the recipient at step 54.

Non-human and user constructed languages

It should further be noted that some characters may not have a recognisable human language equivalent (for example, Pokemon monsters). The thesaurus-based TVS and the character TTS system of the preferred embodimets can optionally be configured such that the text message can be processed to produce audio sounds in the possibly constructed language of the subject character.

Furthermore, another feature involves providing a user-customizable supported word-base within the character TTS system, the customizable supported word-base having means of allowing the user to define which words in the customizable supported word-base are to be supported words and additionally, means of allowing the user to upload into the supported word-base, audio format speech samples to provide suitable recorded speech units for each supported word in said supported word-base. Said audio format speech samples can equally be recordings of the user's own voice or audio format samples extracted from other sources (for example, recordings of a television series).

This allows a user or an agent on behalf of a plurality of users to chose or design their own characters with a non-human or semi-human language, or to design and record the audio sound of the entirety of the character's spoken language and to identify key human-language words, phrases and sentences that a user will use in a text message, to trigger the character to speak the correct sequence of it's own language statements.

By way of example, consider the popular Pokemon character Pikachu which speaks a language made up of different intonations of segments of its own name. A user or an agent (for example, Pokemon witer) could configure an embodiment having a supported word-base and corresponding audio format speech samples as follows:

| | |
|---|---|
| Hello | “Peeekah”, |
| I | “Ppppeeee”, |
| Will | “KahKah” |
| Jump | “PeeeChuuuChuuu”. |

When the user enters the text message “Hello, I will jump”, the character TTS system causes the following audio format message to be produced “Peeekah Ppppeeee KahKah PeeeChuuuChuuu”. Furthermore, the TVS effectively provides a wider range of text messages that an embodiment can convert to audio format messages than would a system without a TVS. For example, if a user were to enter the following text message. “Welcome, I want to leap”, the TVS would convert said text message to “Hello, I will to jump”. Thereafter, the user could delete the unsupported word “to”, consequently resulting in the generation of the same audio format message as previously described.

Radical prosidy conversion

When a text message is converted to a voice message via the TTS system, the prosidy (pitch and speaking speed) of the message is determined by one or another of the methods previously described. It would be advantageous, however, for the speaking speed of the message to be variable, depending upon factors, such as:

the experience level of the user

native accent of the user

the need for speedy response

how busy the network is (faster response=higher throughput)

This feature is particularly appropriate for users of tolophony voice menu systems (for example, interactive voice response) or IVR systems and other repeat use applications such as banking, credit card payment systems, stock quotes, movie info lines, weather reports etc. The experience level of the user can be determined by one of or a combination of the following or other similar means:

Selection of a menu item early in the transaction

The speed or number of “barge in” requests by the user

Remembering the user's identification

Consider an example of a user rings an automated bill payment phone number and follows the voice prompts which are given in a famous character's voice. The user hits the keys faster than average in response to the voice prompts so that the system responds by speeding up the voice prompts to allow the user to get through the task quicker.

Alternative prosidy generation methods

Typically, prosidy in TTS systems is calculated by analysing the text and applying linguistic rules to determine the proper intonation and speed of the voice output. One method has been described above which provides a better approximation for the correct prosodic model. The method previously described is suitable for applications requiring speech to speech. There are limitations in this method however. For applications where the prosodic model is very important but the user can carefully construct a fixed text message for synthesis, such as in web site navigation or audio banner advertising, another method of prosidy generation (called prosidy training) can be provided whereby the prosodic model is determined by analysing an audio waveform of the user's own voice as he/she reads the entered text with all of the inflection, speed and emotion cues built into the recording of the user's own voice. However, in this situation, rather than using the voice recognition engine to generate the text, for input into the TTS system, the text output from the voice recognition engine is discarded. This reduces the error rate apparent in the text to be streamed to the TTS system.

An additional method of producing better prosodic models for use in TTS systems is similar to the prosidy training method described above but is suitable for use in STS systems. In an STS system, the user's voice input is required to generate the text for conversion by the TTS system to a character's voice. The recorded audio file of the user's input speech can thus be analysed for its prosodic model which is subsequently used to train the TTS system's prosodic response as described above. Effectively, this method allows the STS system to mimic the user's original intonation and speaking speed. Yet another method of producing better prosodic models for use in TTS systems involves marking up the input text with emotional cues to the TTS system. One such markup language is SABLE which looks similar to HTML. Regions of the text to be converted to speech that require specific emphasis or emotion are marked with escape sequences that instruct the TTS system to modify the prosodic model from what would otherwise be produced. For example, a TTS system would probably generate the word ‘going’ with rising pitch in the text message “So where do you think you're going?”. A markup language can be used to instruct the TTS system to generate the word ‘you're’ with a sarcastic emphasis and the word ‘going’ with an elongated duration and falling pitch. This markup would modify the prosidy generation phase of the TTS or STS system. Whilst this method of prosidy generation is prior art, one novel extension is to include emotion markups in the actual corpus (the corpus is the textual script of all of the recordings that make up the recorded speech database) and lots of different emotional speech recordings so that the recorded speech database has a large variation in prosidy and the TTS can use the markups in the corpus to enhance the unit selection algorithm.

Markup language

Markup languages can include tags that allow certain text expressions to be spoken by particular characters. Emotions can also be expressed within the marked up text that is input to the character voice TTS system. Some example emotions include:

Shouting

Angry

Sad

Relaxed

Cynical

Text to speech markup functions

In addition to the methods described above for marking up text to indicate how the text message should be converted to an audio file, a toolbar function or menu or right mouse click sequence can be provided for inclusion in one or more standard desktop applications where text or voice processing is available. This toolbar or menu or right click sequence would allow the user to easily mark sections of the text to highlight the character that will speak the text, the emotions to be used and other annotations, for example, background effects, embedded expressions etc.

For example, the user could highlight a section of text and press the toolbar character button and select a character from the drop down list. This would add to the text, the (hidden) escape codes suitable for causing the character TTS system to speak those words in the voice of the selected character. Likewise, text could be highlighted and the toolbar button pressed to adjust the speed of the spoken text, the accent, the emotion, the volume etc. Visual coding (for example, by colour or via charts or graphs) indicate to the user, where the speech markers are set and what they mean.

Message enhancement techniques

A further aspect relates to the method of encoding a text message with additonal information to allow the character TTS system to embellish the audio format message thus produced, with extra characteristics as described previously. Such embellishments include, but are not limited to: voice effects (for example, “underwater”), embedded expressions (for example, “Hubba Hubba”), embedded song extracts and switching characters (for example, as described in the story telling aspect). The method involves embedding within the text message, escape sequences of pre-defined characters to allow the character TTS system, thus reading said text message to read sequences of letters thus contained between said escape sequences, as special codes which are consequently interpreted independently of the character TTS system's normal conversion process.

The embedding of canned expressions in the audio stream of speech produced from a TTS system is described above. Embedded expressions may be either inserted (for example, clapping, “doh” etc.) or they may be mix inserted where they become part of the background noise, beginning at a certain point and proceeding for a certain period of time (for example, laughter whilst speaking, background song extracts etc.) or for the complete duration of the message.

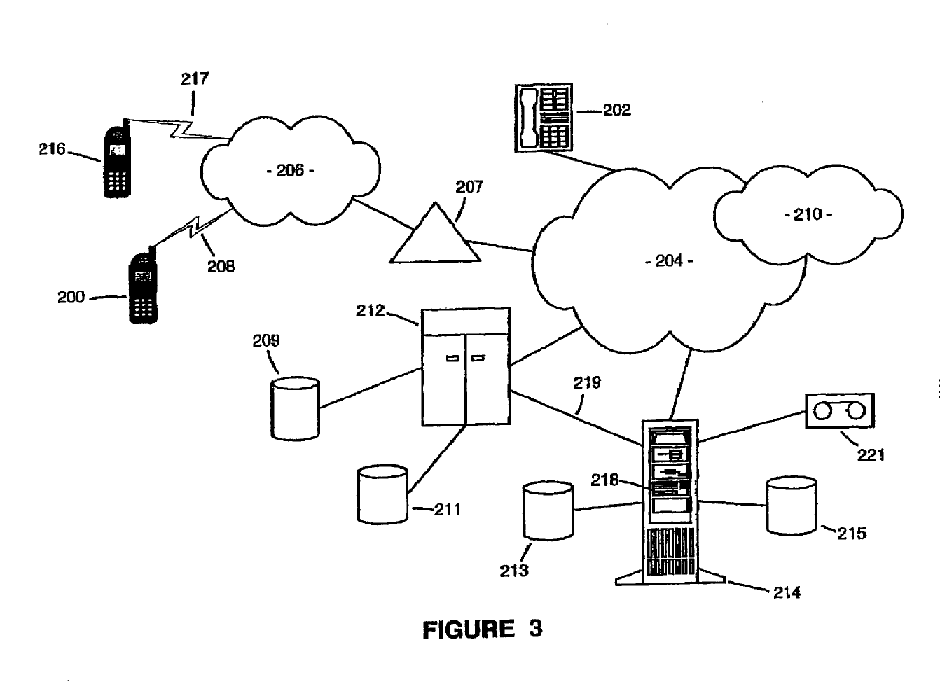

Shown in FIG. 3 is a system that can be used to allow a telephone subscriber to create a message for another user that may be in their own voice, the voice of a well known character and may include an introduction and end to the message together with any background sound effects. Specifically the sender may either use a mobile telephone 200 or a PSTN phone 202 both of which are linked to a communications network which may be the PSTN 204 and whereby the mobile telephone 200 is linked to the PSTN 204 through a cellular network 206 and appropriate gateway 207 (either SMS or WAP) via radio link 208. Thus either a voice message or text message may be transmitted. The PSTN 204 has various signalling controlled through an intelligent network 210 and forming part of the PSTN is a message management centre 212 for receiving messages and a server means 214 that arranges the construction of the message together with background effects and/or in a modified form such as the voice of a famous person. Either or both the MMC 212 and server means 214 may be a message processing means. The server means 214 receives a request from the message management centre 212 which details the voice and any other effects the message is to have prior to construction of the message. The message management centre (MMC) 212 uses an input correction database 209 to correct any parts of the audio message or text message received and a phrase matching database 211 to correct any phrases in the message. The MMC 212 has a text to speech conversion unit for converting any SMS message or text message from the user into an audio message before it is passed onto the server means 214. Once the request is received by the server means 214 it constructs the message using background effects from audio files stored in sound effects database 215 and character voice, with correct prosidy, in the type of message requested using character voice database 213. An audio mixer 221 may also be used. Thus when a user 200 wishes to send a message to another user who may be using a further mobile telephone 216 or a fixed PSTN phone, the sender will contact the service provider at the message management centre 212 and after verifying their user ID and password details will be guided through a step by step process in order to record a message and to add any special effect to that message. Thus the user will be provided with options, generally through an IVR system, in respect of the following subjects;

to give an impression to the recipient of an environment where the sender is, for example at the beach, at a battleground, at a sporting venue, etc. Recordings of these specific sequences are stored in a data store 218 of the server means 214 or database 215 and once the desired option is selected this is recorded by the message centre 212 and forwarded on to the server means 214 over link 219 together with the following responses:

Deciding on a famous voice in which their own voice is to be delivered from a selection of well known characters. The choice is made by the user by depressing a specific button sequence on the phone and this is also recorded by the message centre 212 and later forwarded onto the server 214;

Any introduction or ending that a user particularly wants to incorporate into their message whether that is spoken in a character voice may be chosen. Thus specific speech sequences may be chosen from which to use as a beginning or end in a character voice or constructed by the user themselves by leaving a message which is then converted later into the voice of their chosen character.

Once all of this information is recorded by the message management centre 212 it is forwarded to the server 214 which extracts the message recorded and converts this into the character selected from database 213, using the speech to speech system of the present invention, incorporates the chosen background effect from database 215 which is superimposed on the message and any introduction and ending required by the sender. As a combined message this is then delivered to MMC 212 and to the eventual recipient by the user selecting a recipients number stored in their phone or by inputting the destination phone number in response to the TVR. Alternatively, the recipient's number is input at the start. The message may be reviewed prior to delivery and amended if necessary. The message is then delivered through the network 204 and/or 206 to the recipient's phone to be heard or otherwise left as a message on an answering service.

An alternative to using a character voice is to not use a voice at all and just provide a greeting such as “Happy Birthday” or “Happy Anniversary” which would be pre-recorded and stored in the data storage means 218 or database 213 and is selected by the user through the previously mentioned IVR techniques. Alternatively a song may be chosen from a favourite radio station which has a list of top 20 songs that are recorded and stored in the database 213 and selected through various prompts by a user. The server 214 would then add any message that might be in a character's voice plus the selected song and delivered to the recipient.

With reference to FIG. 4, thee is shown various examples of text entry on a sender's mobile terminal 200. The screen 230 shows a message required to be sent to “John” and “Mary” in Elvis Presley's voice and says hello but is sad. Screen 232 shows a message to be sent in Elvis's voice that is happy and is a birthday greeting. Screen 234 shows a message constructed by a service provider in the voice of Elvis that basically says hello and is “cool”.

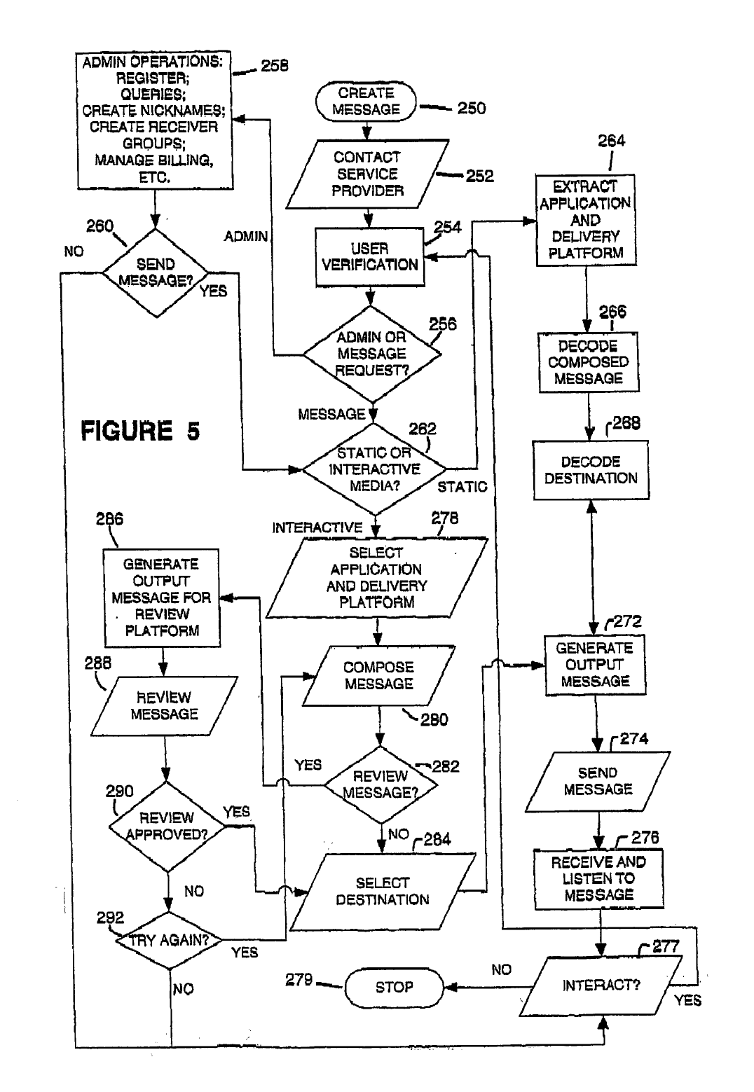

Shown in FIG. 5 is a flow diagram showing the majority of processes involved with the present invention. At step 250 a telephone subscriber desires to create a new message or otherwise contact the service provider at step 252 and then at step 254 the subscriber verifies their user ID and password details. At step 256 the subscriber is asked whether they are required to make administrative changes or prepare a message. If administrative changes or operations are required the process moves to step 258 where a user can register or ask questions, create nicknames for a user group, create receiver groups or manage billing etc. At step 260 the user is prompted to either send the message or not and if a message is desired to be sent the process moves to step 262 which also follows on from step 256. At step 262 one of two courses can be followed, one being a “static” path and the other being an “interactive” path. A static path is generally where a user selects an option that needs to be sent but does not get the opportunity to review the action whereas an interactive process is for example TVR where the user can listen to messages and change them. Thus if the static process is requested the process moves to step 264 where the application and delivery platform are extracted and at step 266 a composed message is decoded and the destination is decoded at step 268. Thereafter at step 272 an output message is generated based on the composed message and decoded destination information and delivered to the recipient at step 274 whereby the recipient receives and listens to the message at step 276. The recipient is then given the option to interact or respond to that message at step 277 which may be done by going back to step 254 where a new message can be created, a reply prepared or the received message forwarded to another user. If no interaction is required, the process is stopped at step 279.

If the interactive path is chosen from step 262 the process moves to step 278 where the selection of an application and delivery platform is performed, the message composed at step 280 and the user prompted at step 282 whether they wish to review that message. If they do not then the process moves to step 284 where the destination or recipient number/address is selected and then the output massage generatd at step 272, delivered at step 274 and received and listened to by the recipient at step 276. If at step 282 the message is requested to be reviewed then at step 286 the output message is generated for the review platform using the server 214 or MMC 212 and voice database 213, the message reviewed at step 288 and acknowledged at step 290 or otherwise at step 292 the message is composed again.

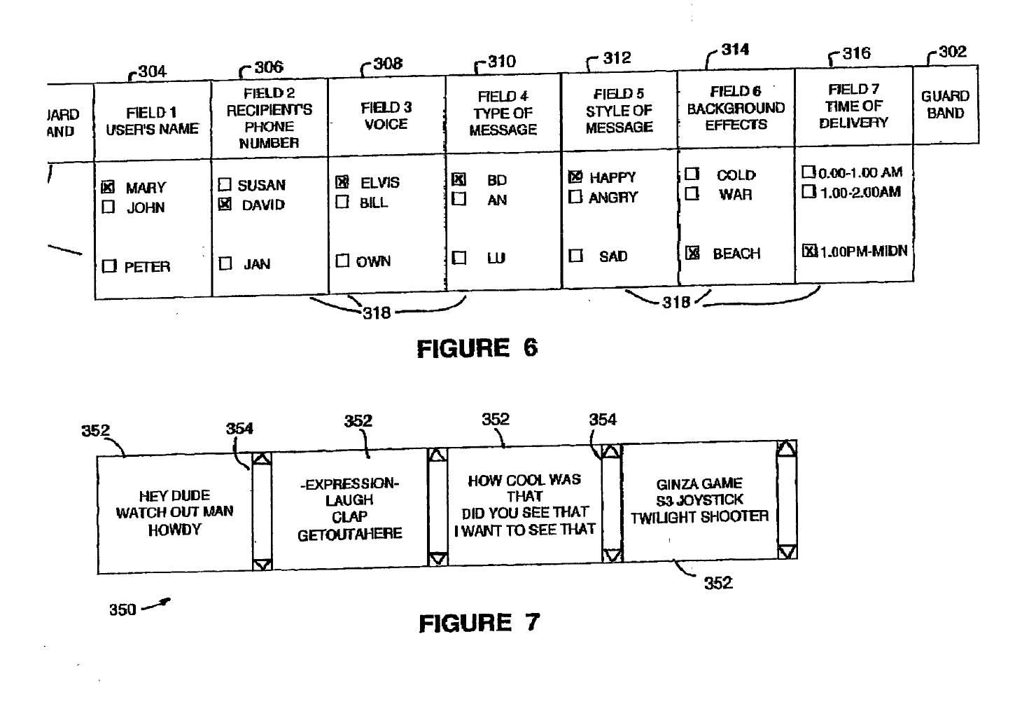

With regard to the input of text on a mobile telephone terminal or PSTN telephone terminal messages may be easily constructed through the use of templates which are sent to the user from the telecommunication provider. In mobile telecommunications the short message sevce or SMS may be used to transmit and receive short text messages of up to 160 characters in length and templates, such as that shown in FIG. 6 allow easy input for construction of voice messages in the SMS environment. In the example shown in FIG. 6 this would appear on the screen of a mobile phone whereby the 160 character field of the SMS text message is divided into a guard band 300 at the start of the message and a guard band 302 at the end of the message and in between these guard bands there may be a number of fields, in this case seven fields in which the first field 304 is used to provide the subscriber's name, the second field 306 denotes the recipient's telephone number, the third field 308 is the character voice, the fourth field 310 is the type of message to be sent, the fifth field 312 is the style of message, the sixth field 314 indicates any background effects to be used and the seventh field 316 is used to indicate the time of delivery of the message. In each of the fields 304 to 316, as shown in the expanded portion of the figure there may be a number of check boxes 318 for use by the sender to indicate the various parts of the type of message they want to construct. All the user has to do is mark an X or check the box against which of the various options they wish to use in the fields. For example the sender indicated by Mary in field 304 may want to send a message to receiver David's phone number in a character voice of Elvis Presley with a birthday message that is happy and having a background effect of beach noises with a message being sent between 11 pm and midnight. As mentioned previously various instructions may be provided by the telecommunications provider on how to construct this type of message and after it has been constructed the user need only press their send button on their mobile telephone terminal and the instructed message is received by the MMC 212, translated into voice and sent to server means 214 which constructs the message to use the character voice specified which is stored in the database 213 and then sent to the recipient. The server essentially strips out the X marked or checked options in the constructed message and ignores the other standard or static information that is used in the template.

Alternatively a template may be solely constructed by the subscriber themselves without having to adhere to the standard format supplied by telecommunications provider such as that shown in FIG. 6.

A set of templates may alternatively be sent from user to user either as part of a message or when a recipient asks “How did you do that?” Thus instructions may be sent from user to user to show how such a message can be constructed and sent using the templates. Any typed in natural language text as part of the construction of the message where users use their own templates or devise their own templates is processed in steps 264 and 266 shown in FIG. 5 or alternatively steps 278 and 280 using the server means 14. Thus an audio message is delivered as part of a mapping process to the recipient whereby the input text speech is converted into such an audio message from the template shorthand. The server means 14 can determine coding for the templates used including any control elements. As an example each of the fields 304-316 have been devised and set by the server means 214 or MMC 212 to depict a particular part of the message to be constructed or other characteristics such as the recipients telephone number and time of delivery. The server means (or alternatively MMC 212) can determine a dictionary of words that fit within the template structure for example for voice, Elvis can equal Elvis Presley, Bill can equal Bill Clinton or for example the type of message BD=birthday, LU=love you.

The recipient of a message can edit the SMS message and send that as a response to the sender or forward it on to a friend or another user. This is converted by the server means to resend a message in whatever format is required, for example an angry message done with war sound effects as a background and sent at a different time and in a different character voice.

Alternatively pre-set messages may be stored on a users phone whereby a message may be extracted from the memory of the phone by depressing any one of keys on the phone and used as part of the construction of the message to be sent to the recipient. Effects can be added to a message during playback thereof at various times or at various points within that message on depressing a key on the telephone. For example at the end of each sentence of a message a particular background affect or sound may be added.

As an example of the abovementioned concepts using SMS messages, somebody at a football sporting event can send a message via SMS text on their mobile phone to a friend in the stadium. They can simply enter the words “team, boo” and the receivers phone number. After the message is processed the receiver gets a voice message in a famous players voice with background sound effects saying “a pity your team is losing by 20 points, there is no way your team is going to win now”. The receiver can immediately turn this around and send a reply by depressing one or two buttons on their telephone and constructing an appropriate response. Alternatively they can edit the received message or construct a new message as discussed above.

The above concepts are equally applicable to use over the Internet (communications network 204) whereby each of the mobile devices 200 or equivalently PDA or mobile computing terminals that are all WAP enabled can have messages entered and sent to the server means 214 and constructed or converted into an audio message intended for a particular recipient.

A particular message constructed by a subscriber may be broadcast to a number of recipients whereby the subscriber has entered the respective telephone numbers of a particular group in accordance with step 258 of FIG. 5. This may be done either through a telecommunications network or through the Internet via websites. A particular tag or identifier is used to identify the group to which the message, such as a joke may be broadcast to and the MMC 212 and the server means 214 receives the message and decodes the destination data which is then used for broadcast via an IVR select destination to each one of the members of that group. This in essence is a viral messaging technique that produces a whole number of calls from one single message. For each of the recipients of the broadcast message, such a message can be reconstructod as another message and forwarded onto another user or a group of users or replied to.

Shown in FIG. 7 is a series of drop down menus 350 that will typically be transmitted from a server means 214 through the MMC 212 to a respective mobile terminal 200 in order to allow the user of the mobile terminal 200 to construct a message based on preset expressions 352 included in each of the drop down menus. Thus all the user has to do is highlight or select a particular expression in each window of the drop down menus to construct a sentence or a number of expressions in order to pass on a message to one or more recipients. This may alternatively be done through the Internet whereby a computing terminal or a mobile phone or PDA that is WAP enabled may be used to construct the same message. It is then forwarded and processed by the MMC 212 which converts it to an audio message in the manner above described. Each message can include other effects such as the background sounds or expressions mentioned previously. Scroll bars 354 are used to scroll through the various optional phrases or parts of the sentence/message to be constructed.

Another embodiment to the present invention is a system whereby words or expressions uttered by famous characters are scrutinised and managed to the extent that certain words are not allowed to be uttered by the particular character. In a particular context some characters should not say certain words or phrases. For example a particular personality may have a sponsorship deal with a brand that precludes the speaking of another brand or the character or personality may wish to ensure that their voice does not say certain words in particular situations.

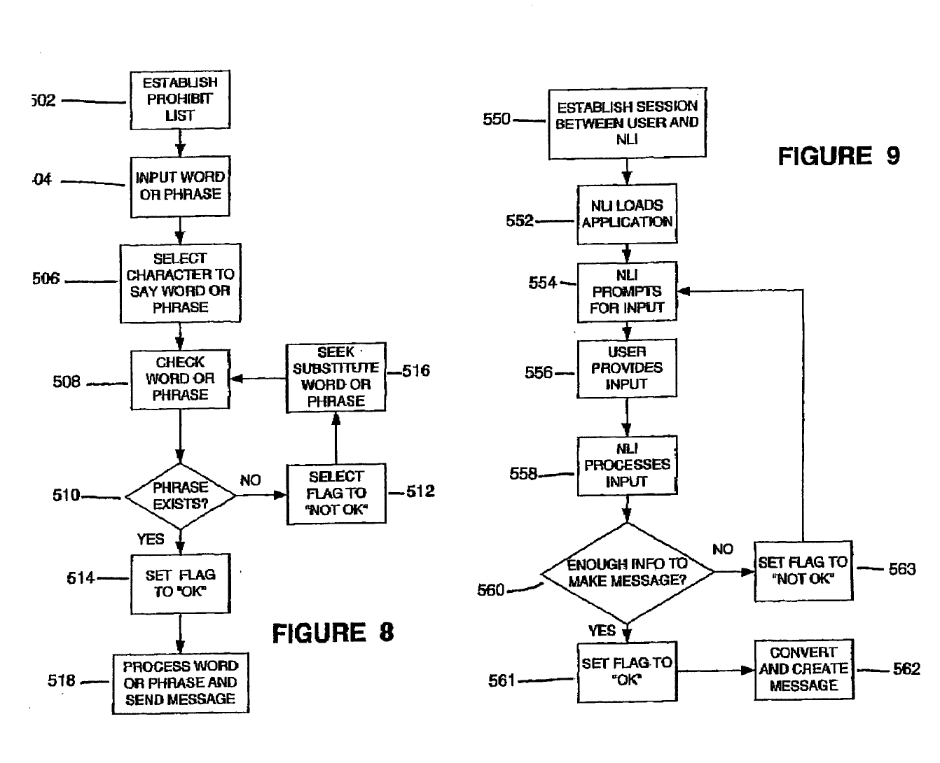

Shown in FIG. 8 is a flow chart showing processes involved for when a word or phrase is not to be spoken by the selected character. At step 502 a prohibit list is established for the character or personality in a database which may be database 211 or a storage means 218 of the server means 214. In this database 211 would be contained a list of words or expressions that are not to be uttered by the selected character. At step 504 the user inputs the words or phrase and at step 506 selects the character or personality to say a particular word or phrase. At step 508 the server means will check in the database the word or phrase against the character or personality prohibit list in the particular database 211. At step 510 a query is ascertained if the word or phase exists in the prohibit list in the database for a particular character and if so a prohibit flag is set against that word or phrase as being not OK. This is done at step 512. If the word or phrase does not exist in the prohibit list in the database for that particular character then a prohibit flag is set against that word or phrase as being OK at step 514. After step 512 a substitute word or phrase from a digital thesaurus, which may form part of database 209, is searched and found at step 516 and is then used in the text based message (or audio message) and the process goes back to step 508. If the prohibit flag is OK as in step 514 then the process continues and the word or phrase is used in the message and then delivered in step 518.

Shown in FIG. 9 are process steps used in accordance with a natural language conversion system whereby a user can enter or select a natural language input option from a drop down menu on their terminal to establish a session between the user and a natural language interface (NLI). This is due at step 550. Then at step 552 the NLI loads an application or user specific prompts/query engine and the NLI at step 554 prompts for the natural language user input by automated voice prompts. Thus the user will be directed to ask questions or make a comment at step 556. After that at step 558 the NLI processes the natural language input from the user and determines a normalized text outcome. Thus a natural question from a user is converted into predefined responses that are set or stored in a memory location in the server means 214 for example. At step 560 a query is asked as to whether there is sufficient information to proceed with a message construction. If the answer is yes then a “proceed” flag is set to “OK” at step 561 and at step 562 conversion of the user input using the normalised text proceeds to create the message. If there is not enough information to proceed with the message construction then a “proceed” flag is set to “not OK” at step 563 and the process goes back to step 554 for further prompts for a natural language user input. The above system or interface is done through a telecommunications system or other free form interactive text based system, for example, email, chat, speech text or Internet voice systems.

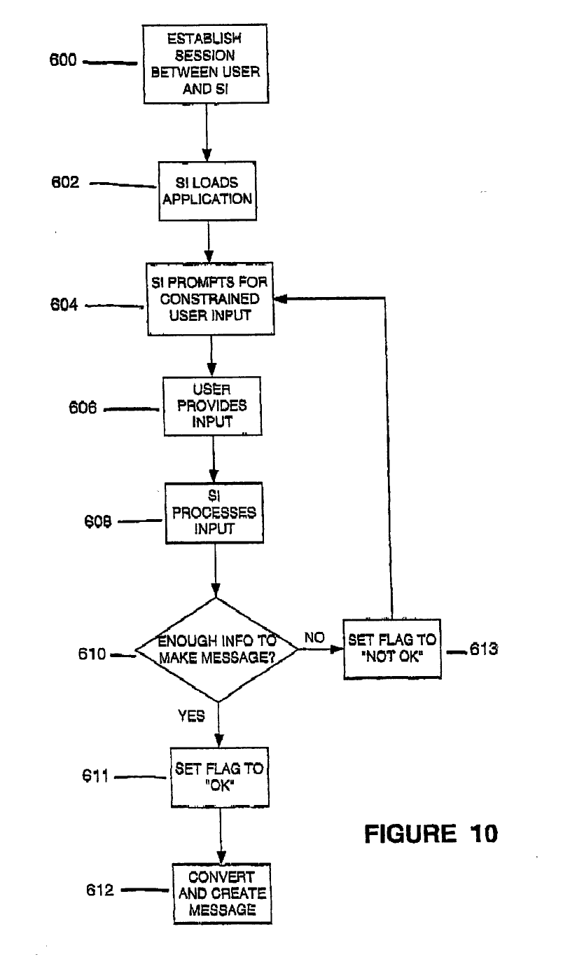

Shown in FIG. 10 is process steps used by a user to construct a message using a speech interface (SI). Users will interface via a telephony system or other constrained interactive text based system which will input their responses to queries and convert such responses into normalised text for furhter conversion into a message via the techniques already outlined. Thus in step 600 a session is established between the user and the speech interface, which may be part of the server means 214 or MMC 212. At step 602 the speech interface loads the application or uses specific prompts/query engine and at step 604 the speech interface prompts the user for constrained language user input via automated voice prompts. At step 606 the user provides the constrained language user input and at step 608 the speech interface processes the constrained language user input and determines normalised text from this.

Examples of constrained language user input include the following question and answer sequence:

Q: Where would you like to travel?

A: Melbourne or

A: I would like to go to Melbourne on Tuesday. or

A users says: “I want to create a birthday message in the voice of Elvis Presley”.

Based on the information received the MMC 212 or server 214 determines from stored phrases and words if a message can be constructed.

At step 610 a decision is made by the MMC 212 or server 214 as to whether enough information has been processed in order to construct a message. If not enough information has been provided then at step 614 the process reverts (after setting the “proceed” flag to “not OK” at step 613) back to step 604 (where the speech interface prompts for further constrained user input. If there is sufficient information from step 610 the process proceeds to step 612 (after setting the “proceed” flag to “OK” at step 611) with the conversion of the user input using normalised text in order to create the message.

Expressions can be added by a What you See is What You Hear (WYSIWYH) tool described in a following section or during regular textual data entry by pressing auxiliary buttons, selecting menu items or by right mouse click menus etc. The expression information is then placed as markups (for example, SABLE or XML) within the text to be sent to the character voice TTS system.

Laughig, clapping and highly expressive statements are examples of embeddable expressions. However, the other additional quality enhancing features can be added. Background sounds can be mixed in with the audio speech signal to mask any inconsistencies or unnaturalness produced by the TTS system. For example, a system programmed to provide a TTS system characterized with Murray Walker's voice (F1 racing commentator) could be mixed with background sounds of screaming Formula One racing cars. A character TTS system for a sports player personality (such as for example, Muhammed Ali) could have sounds of cheering crowds, punching sounds, sounds of cameras flashing etc mixed into the background. A character TTS system for Elvis Presley could have music and/or sing mixed into the background.

Baclground sounds could include, but arr not limitd to, white noise, music, singing, people talking, normal background noises and sound effects of various kinds.

Another class of technique for improving the listening quality of the produced speech involves deliberately distorting the speech, since imperfections in natural voice syntheses are more sensitive to the human ear than are imperfections in non-natural voice syntheses. Two methods can be provided for distorting speech while maintaining the desirable quality that the speech is recognisable as the target character. The first of these two methods involves applying post-process filters to the output audio signal. These post-process filters provide several special effects (for example, underwater, echo, robotic etc.). The second method is to use the charteristics of the speech signal within a TTS or STS system (for example, the phonetic and prosodic models) to deliberately modify or replace one or more components of the speech waveform. For example, the FO signal could be frequency shifted from typical male to typical female (ie, to a higher frequency), resulting in a voice that sounds like, for example Homer Simpson, but in a more female, higher pitch. Or the FO signal could be replaced with an FO signal recorded from some strange source (for example, lawn mower, washing machine or dog barking). This effect would result in a voice that sounded like a cross between Homer Simpson and a washing machine, or a voice that sounds like a pet dog, for example.

Text Input, expresions and filters

When interacting with the Web site to construct personalised text messages for conversion to the chosen character's voice, the first or second user enters a Web page dedicated to the chosen character (for example, Elvis Presley Page). Preferably, each character page is similar in general design and contains a message construction section having a multi-line text input dialogue box, a number of expression links or buttons, and a special effects scroll list. The first or second user can type in the words of the message to be spoken in the multi-line text input dialogue box and optionally include in this message, specific expressions (for example, “Hubba Hubba”, “Grrrrrr”, Laugh) by selection of the appropriate expression links or buttons.

Pre-recorded audio voice samples of these selected expressions are automatically inserted into the audio format message thus produced by the character TTS system. The text message or a portion of the text message may be marked to be post-processed by the special effects filters in the software by preferably selecting the region of text and selecting an item from the special effects scroll list. Example effects may include, for example “under water” and “with a cold” effects that distort the sound of the voice as expected.

It should be noted that while the Web site is used as the preferred user interface, any other suitable user interface methods (for example, dedicated software on the user's compatible computer, browser plug-in, chat client or email package) can easily be adapted to include the necessary features without detracting from the user's experience.

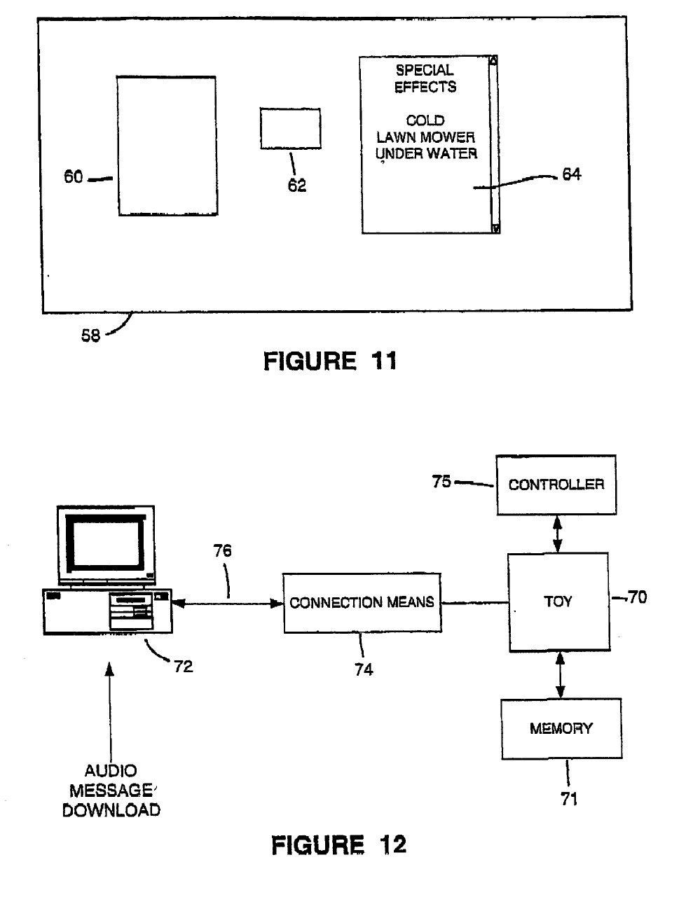

By way of example, shown in FIG. 11 is a web page 58 accessed by a user who wishes to construct a message, which web page may reside on a server such as server means 10 or another server linked to the Internet 4. Once the website is accessed the user is presented with a dialogue box 60 for the input of text for the construction of the message. A further box 61 is used, by the user clicking on this box, which directs the user to various expressions as outlined above that they may wish to insert into the message at various locations in that message. A further box 64 for the inclusion of special effects, such as “under water” or “with a cold” may be applied to all of or a portion of the message by the user selectng and highlighting the particular special effect they wish the message to be delivered in. The message is then sent to the recipient by the user typing in the email address, for example for the recpient to hear the message with any expressions or special effects added thereto in the voice of the character at this particular website that was accessed by the sender.

Unauthorised use of a voice

A character voice TTS generated audio format file can be protected from multiple or unauthorised use by encryption or with time delay technology. It is desirable to retain control of use of the characters' voices. Amongst other advantages, this can assist in ensuring that the characters' voices are not inapropriately used or that copyrights are not abused contrary, for example, to any agreement between users and a licensor entity. One method of implementing such control measures may involve encoding audio format voice files in a proprietary code and supplying a decoder/player (as a standalone software module or browser plug-in) for use by a user. This decoder may be programmed to play the message only once and discard it from the user's computer thereafter.

Speech to speech systems

A logical extension to the use of a TTS system for some of the applications of our invention is to combine the TTS system with a speech recognition engine. The resulting system is called a speech to speech (STS) system. There are two main benefits of providing a speech recognition engine as a front end to the invention.

1. The user can speak input into the system rather than having to type the input.

2. The system cam analyse the prosidy (pitch and speed) of the spoken message, in order to provide a better prosodic model for the TTS system than can be obtained purely from analysing the text. This feature is optional.

There are two streams of research in speech recognition systems. These are:

Speaker independent untrained recognition. The strength of this type of system is that it is good at handling many different user's voices without requiring the system to be trained to understand each voice. Its applications include telephony menus etc.

Speaker dependent trained recognition. The strength of this type of system is that the speech recognition system can be trained to better understand one or more specific users' voices. These systems are typically capable of continuous speech recognition from natural speech. They are suitable for dictation type applications and particularly useful for many of the applications for our invention, particularly email and chat.

The use of speech recognition and text to speech systems can be advantageously used for the purpose of voice translation from one character's voice (ie. user) to another character's voice in the same human language.

To obtain a prosodic model from the spoken (is. the user's) message, for use in an STS system, an additional module needs to be added to the speech recognition system, which continuously analyses the waveform for the fundamental frequency of the larynx (often called FO), pitch variation (for example: rising or falling) and duration of the speech units. This information, when combined with the phonetic and text models of the spoken message, can be used to produce a very accurate prosodic model which closely resembles the speed and intonation of the original (user's) spoken message.

Character-based stories

The first or second user can select a story for downloading to the first user's computer or toy. The first user may optionally select to modify the voices that play any or each of the characters and/or the narrator in the story by entering a web page or other user interface component and selecting each character from drop down lists of supported character voices. For example, the story of Snow White could be named by Elvis Presley. Snow White could be played by Inspector Gadget, the Mirror by Homer Simpson and the Wicked Queen by Darth Vader.

When the software subsequently processes the story and produces the audio format message for the story, it preferably concatenates the story from segments of recorded character voices. Each segment may be constructed from sound bites of recorded words, phrases and sentences or optionally partially or wholly constructed using the character TTS system.

Message directory

A database of messages for a specific user's use can be provided. The database contains information relating to an inventory of the messages sent and received by the user. The user may thereafter request or otherwise recall any message previously sent or received, either in original text form or audio format form for the purposes of re-downloading said message to a compatible computer or transferring the message to another user by way of the Internet email system.

In the case of a toy embodiment, one or more selected audio format messages can be retransferred by a user. The audio format message may have previously been transferred to the toy but may have subsequently been erased from the non-volatile memory of the toy.

The database may be wholly or partially contained within Internet servers or other networked computers. Alternatively, the database may be stored on each individual user's compatible computer. Optionally, the voluminous data of each audio format message may be stored on the user's compatible computer with just the indexing and relational information of the database residing on the Internet servers or other networked computers.

Jokes and daily messages

Another feature relates to the first or second user's interaction sequences with the software via the Web site, and the software's consequential communications with the first user's compatible computer and in the toy embodiment, subsequent communications with the first user's toy.

A Web site can be provided with access to a regularly updated database of text or audio based jokes, wise-cracks, stories, advertisements and song extracts recorded in the supported characters' voices or impersonations of the supported characters' voices or constructed by processing via the character TTS system, of the text version of said jokes, wise-cracks and stories.

The first or second user can interact with the Web site to cause one or more of the pre-recorded messages to be downloaded and transferred to the first user's computer or, in toy-based embodiments, subsequently transferred to the first user's toy as described above.

Optionally, the first or second user, and preferably the first user, can cause the software to automatically download a new joke, wise-crack, advertisement, song extract and/or story at regular intervals (for example, each day) to the first user's computer or toy or send a notification via email of the existence of and later collection of the new item on the Web site.

It should be noted that the database of items can be extended to other audio productions as required.

Email and greeting cards

A second user with a computer and Web browser and/or email software can enter or retrieve a text message into the software and optionally, select the character whose voice will be embodied in the audio format message.

The software performs the conversion to an audio format message and preferably downloads the audio format message to the first user. Alternatively, the first user is notified, preferably by email, that an audio format message is present at the Web site for downloading. The first user completes the downloading and transfer of the audio format message as described above. This process allows a first user to send an electronic message to a second user, in which the message is spoken by a apecific character's voice.

In the toy embodiment, the audio format message is trasferred to the toy via the toy's connection means, thereby enabling a toy, which for portability, can be disconnected from the compatible computer to read an email message from a third party in a specific character's voice.

The audio file of the speech (including any expressions, effects, backgrounds etc.) produced by the TTS may be transmitted to a recipient as an attachment to an email message (for example: in .WAV or .MP3 format) or as a streamed file (for example: AU format). Alternatively, the audio file may be contained on the TTS server and a hypertext link included in the body of the email message to the recipient. When the recipient clicks on the hyperlink in the email message, the TTS server is instructed to then transmit the audio format file to the recipient's computer, in a streaming or non-streaming format.

The audio format file may optionally be automatically played on the recipient's computer during, or inmediately following download. It may also optionally be saved on the recipient's storage media for later use, or forwarded via another email message to another recipient. It may also utilise streaming audio to deliver the sound file whilst playing.

The email message may optionally be broadcast to multiple recipients rather than just sent to a single recipient. Either the TTS server may determine or be otherwise automatically instructed as to the content of the recipient list (for example: all registered users' whose birthdays which are today) or instructed by the sender on a list of recipients.

The text for the email message may be typed in or it may be collected from a speech recognition engine as described elsewhere in the section on Speech To Speech (STS) systems.

In addition to sending an audio message via email in a particular character voice, an email reading program can be provided that can read incoming text email messages and convert them to a specific character's voice.

Alternatively, the email may be in the form of a greeting card including a greeting message and a static or animated visual image.

Consider an example of sending an e-mail or on-line greeting card, and having the message spoken in the voice of John Wayne, Bill Clinton, Dolly Parton, Mickey Mouse™ or Max Smart. The sender can enter the text into the e-mail or digital greeting card. When the recipient receives the e-mail or card and opens it there are famous character voices speaking to the recipient as if reading the text that the sender had inserted. There could be one or more characters speaking on each card—or more than one at a time—and the speech could be selected to speak normally, shout, sing or laugh and speak—with background effects and personal mannerisms included.

Another feature of certain embodiments is a Speech Recognition (SRS) system which may be optionally added to the email processing system described above. The SRS system is used by a user to convert his own voice into a text message, the text message thereafter being converted to a character's voice in an audio format message by the character TTS system. This allows a user to have a spoken message converted to another character's voice.

Chat rooms

Users can be allowed to interact with an Internet chat server and client software (for example, ICQ or other IRC client software) so that users of these chat rooms and chat programs, referred to herein as “chatters”, can have incoming and/or outgoing text messages converted to audio format messages in the voice of a specific character or personality. During chat sessions, chatters communicate in a virtual room on the Internet, wherein each chatter types or otherwise records a message which is displayed to all chatters in real-time or near real-time. By using appropriate software or software modules, chat software can be enhanced to allow chatters to select from available characters and have their incoming or outgoing messages automatically converted to fun audio character voices thus increasing the enjoyment of the chatting activity. Optionally, means of converting typical chat expressions (for example, LOL for “laugh a lot”) into an audio equivalent expression are also provided.

The voices in voice chat to be modified to those of specific famous characters. Input from a particular user can either be directly as text via input from the user's keyboard, or via a speech recognition engine as part of an STS system as described below. The output audio is streamed to all users in the chat room (who have character chat enabled) and is synchronised with the text appearing from each of the users (if applicable).

A single user may either select a character voice for all messages generatd by himself and in this scenario and each chat user will speak in his/her own selected character voice. Another scenario would allow the user to assign character voices from a set of available voices to each of the users in the chat room. This would allow the user to listen to the chat session in a variety of voices of his choosing, assigning each voice to each character according to his whim. He/she would also then be able to change the voice assignments at his/her leisure during the chat session.

The chat user may add background effects, embedded expressions and perform other special effects on his or other voices in the chat room as he/she pleases,

The chat room may be a character-based system or a simulated 3D world with static or animated avatars representing users within the chat room.

Chat rooms may be segmented based on character voice groupings rather than topic, age or interests as is common in chat rooms today. This would provide different themes for different chat rooms (eg. a Hollywood room populated by famous movie stars, a White House room populated by famous political figures etc.

Consider the example of a chat session on the Internet in which you select the character whose voice you want to be heard. This includes the option that you are heard as a different character by different people. As a result your chat partner hears you as, for example, Elvis for every word and phrase you type; and you can change character as many times as you like at the click of the mouse. Alternatively, your chat partner can select how they want to hear you.

Voice enabling avatars in simulated environments

This application is very similar to 3D chat in that multiple computer animated characters are given voice personalities of known characters. Users then design 3D simulated worlds/environments and dialogues between characters within these worlds.

An example is a user enters into a 3D world by way of a purchased program or access via the Internet. Within this world, the user can create environments, houses, streets, etc. The user can also create families and communities by selecting people and giving them personalities. The user can apply specific character voices to individual people in the simulated world and program them to have discussions with each other or others they meet in the voice of the selected character(s).

Interactive audio systems

A further feature adapts the system to work in conjunction with telephone answering machines and voice mail systems to allow recording of the outgoing message (OGM) contained within the answering machine or voice mail system. A user proceeds to cause an audio format message in a specific character's voice to be generated by the server means 10, for example, as previously described. Thereafter, the user is instructed on how to configure his answering machine or voice mail system to receive the audio format message and record it as the OGM.

The method may differ for different types of answering machines and telephone exchange systems. For example, the server means 10 will prferably dial the user's answering machine and thereafter, send audio signals specific to the codes required to set said user's answering machine to OGM record mode and thereafter, play the audio format message previously created by said user, over the connected telephone line, subsequently causing the answering machine to record the audio format message as its OGM. Thereafter, when a third party rings the answering machine, they wil be greeted by a message of the user's creation, recorded in the voice of a specific character or personality.

Interactive voice response systems

Various response systems are available in which an audio voice prompts the user to enter particular keypad combinations to navigate through the available options provided by the system. Embodiments can be provided in which the voice is that of a famous person based on a text message generated by the system. Similarly, information services (such as, for example, weather forecasts) can be read in a selected character's voice.

Other navigation systems

Internet browsing can use character voices for the delivery of audio content. For example, a user, utilising a WAP-enabled telephone or other device (such as a personal digital assistant) can navigate around a WAP application either by keypad or touch screen or by speaking into the microphone at which point a speech recognition system is activated to convert the speech to text, as previously described. These text commands are then operated upon via the Internet to perform typical Internet activities (for example: browsing, chatting, searching, banking etc). During many of these operations, the feedback to the user would be greatly enhanced if it was received in audio format and preferably in a recognisable voice.

For such an application, the system can be applied to respond to requests for output to the device. Equally, a system could be provided that enable a character voice TTS sstem to be used in the above defined way for delivering character voice messages over regular (ie non-WAP enabled) telephone networks.

Consider the example of a user who speaks into a WAP enabled phone to select his favourite search engine. He then speaks into his phone to tell the search engine what to look for. The search engine then selects the best match and reads a summary of the Web site to the user by producing speech in a character voice of the user's or the site owner's selection by utilising the character voice TTS system.

Web navigation and Web authoring tools

A Web site can be character voice enabled such that certain information is presented to the visitor in spoken audio form instead of, or as well as, the textual form. This information can be used to introduce visitors to the Web site, help them navigate the Web site and/or present static information (for example: advertising) or dynamic information (for example: stock prices) to the visitor.

Software tools can be provided which allow a Webmaster to design character voice enabled Web site features and publish these features on the World Wide Web. These tools would provide collections of features and maintenance procedures. Example features could include:

Character voice training software

Character voice database enhancement and maintenance software

Text entry fields for immediate generation of voice audio files

WYSIWYH (What you see is what you hear) SABLE markup assistance and TTS robot placement and configuration tools

Database connectivity tools to allow dynamic data to be generated for passing to the TTS system ‘on-the-fly’

Tools for adding standard or custom user interactive character voice features to web pages (for example, tool to allow a character voice chat site to be included in the web master's web page).

The WYSIWYH tool is the primary neans beywhich a Web master can character voice enable a Web site. It operates similarly and optionally in conjunction with other Web authoring tools (for example, Microsoft Frontpage) allowing the Webmaster to gain immediate access to the character voice TTS system to produce audio files, to mark up sections of the web pages (for example, in SABLE) that will be delivered to the Internet user in character voice audio format, to place and configure TTS robots within the web site, to link data-base searches to the TTS system and to configure CGI (or similar) scripts to add character voice TTS functionality to the Web serving software.

TTS robots (or components) are interactive, Web deliverable components which, when activated by the user, allows him/her to interact with the TTS system enabled applications. For example, a Web page may include a TTS robot mail box which, when the user types into the box and presses the enclosed send button, the message is delivered to the TTS system and the audio file is automatically sent off to the user's choice of recipient. The WHYSIWYH tool makes it easy for the Webmaster to add this feature to his/her Web site.

Note that the Internet link from the Web server to the character voice TTS system is marked as optional. The character voice TTS system may be accessible locally from the Web server or may be purely software within the Web server or on an internal network) or it may be remotely located on the Internet. In this case, all requests and responses to other processes in this architeure will be routed via the Internet.

The WHYSIWYH tool can also be used to configure a Web site to include other character voice enabled features and navigation aids. These may include, for example:

When you float over a button with the cursor, it ‘speaks’ the button function, rather than the normal text box.

Character voices when used in demo areas

Advertising

To automatically recommend a character voice, based on a user's known preferences—these could be asked for in a questionnaire or, with sites that store historic data on users, these could be suggested (for example, if a person on Amazon.com buys a lot of history books—it could recommed Winston Churchill as the navigator). Alternatively, a character's voice can automatically be selected for the user (for example, based on specific search criteria).

To automatically create conversation between the users preferred voice navigator (for example, the user has software that automatically makes Homer Simpson his navigator) and the selected navigator of the web site (Say, Max Smart)—it creates an automatic conversation—“Hey Homer, welcome to my site—its Max Smart here”.

Consider the example of a Webmaster who updates a famous person's web site daily with new jokes and daily news by typing into the WHYSIWYH tool, the text of the jokes and news. The Web server then serves up the audio voice of the famous person to each user surfing the Web who selects this page. Conversion from text to speech can be performed at preparation time and/or on demand for each user's request.

Consider the example of a famous person's Web site (a “techno” band or David Letterman site for example) which lets you “dialogue” with the famous person as if they are there just with you—all day and every day—but is actually a text operator typing out the return text message which converts to the famous person's voice at your end.

Now consider the example of a favourite sports Web site and having a favourite sports star give you the commentary or latest news—then select another star and listen to them, then have Elvis do it for amusement.

Set top boxes and digital broadcasting

A set top box is the term given to an appliance that connects a television to the Internet and usually also to the cable TV network. To assist in brand distinction, the audio messages used to prompt a user during operation of such a device can be custom generated from either an embedded character voice TTS system or a remotely located character voice TTS system (connected via Internet or cable network).

In a digital TV application, a user can select which characters they want to speak the news or the weather and whether the voice will be soft, hard, shouting or whispering for example.

Other applications

Other applications incorporating embodiments of the invention include:

Star chart readers

Weather reports

Character voice enabled comic strips

Animated character voice enabled comic strips

Talking alarm clocks, calendars, schedule programs etc.

Multi-media presentations (for example, Microsoft Powerpoint slide introductions)

Talking books, either Web based or based on MP3 handheld players or other audio book devices

Mouse tooltip annunciator

or other voice enabled applications, whereby the spoken messages are produced in the voice of a character, generally recognisable to the user.

Client server or embedded architectures

Some or all of the components of the system can either be distributed as server or client software in a networked or internetworked environment and the split between functions of server and client is arbitrary and based on communications load, file size, compute power etc. Additionally, the complete system may be contained within a single stand alone device which does not rely on a network for operation. In this case, the system can be further refined to be embedded within a small appliance or other application with a relatively small memory and computational footprint for use in devices such as set-top boxes, Net PCs, Internet appliances, mobile phones etc.

The most typical architecture is for all of the speech recognition (if applicable) to be performed on the client and the TTS text message conversion requests to pass over the network (for example, Internet) to be converted by one or more servers into audio format voice messages for return to the client or for delivery to another client computer.

Construction of new character voices

The character TTS system can be enhanced to facilitate rapid additions of new voices for different characters. Methods include on-screen tuning tools to allow the speaker to “tune” his voice to the required pitch and speed, suitable for generating or adding to the recorded speech data-base, recording techniques suitable for storing the speech signal and the laringagraph (EGG) signal, methods for automatically processing these signals and methods for taking these processed signals and creating a recorded speech data-base for a specific character's voice and methods for including this recorded speech data-base into a character TTS system.

Voice training and maintenance tools can be packaged for low cost deployment on desktop computers, or provided for rent via an Application Service Provider (ASP). This allows a recorded speech database to be produced for use in a character voice TTS system. The character voice TTS system can be packaged and provided for use on a desktop computer or available via the Internet in the manner described previously, whereby the user's voice data-base is made available on an Internet server. Essentially, any application, architecture or service provided as part of this embodiment could be programmed to accept the user's new character voice.

As an example, the user buys from a shop or an on-line store a package which contains a boom mike, a laringagraph, cables, CD and headphones. After setting up the equipment and testing it, the user then runs the program on the CD which guide's the user through a series of screen prompts, requesting him to say them in a particular way (speed, inflection, emotion etc.). When complete, the user then instructs the software to create a new ‘voice font’ of his own voice. He now has a resource (ie: his own voice database) that he can use with the invention to provide TTS services for any of the described applications (for example, he could automatically voice enable his web-site) with daily readings from his favourite on-line e-zine).

Further, his application allows a person to store his or her voice forever. Loved ones can then have your voice read a new book to them, long after the original person has passed away. As technology becomes more advanced, the voice quality will improve from the same recorded voice data-base.

Method for recording audio and video together for use in animation

The process of recording the character reading usually involves the use of a closely mounted boom microphone and a laringagraph. The laringagraph is a device that clips around the speaker's throat and measures the vibration frequency of the larynx during speech. This signal is used during development of the recorded speech database to accurately locate the pitch markers (phoneme boundaries) in the recorded voice waveforms. It is possible to synchronously record a video signal of the speaker whilst the audio signal and laringagraph signal is being recorded and for this signal to be stored within the database or cross referenced and held within another database. The purpose of this extra signal would be to provide facial cues for a TTS system that included a computer animated face. Additional information may be required during the recording such as would be obtained from sensors, strategically placed on the speaker's face. During TTS operation, this information could be used to provide an animated rendering of the character, speaking the words that are input into the TTS.

In operation, when the TTS system retrieves recorded speech units from the recorded speech database, it also retrieves the exact recorded visual information from the recorded visual database that coincides with the selected speech unit. This information is then used in one of two ways. Either, each piece of video recording corresponding to the selected units (in a unit selection speech synthesiser) is concatenated together to form a video signal of the character as if he/she were actually saying the text as entered into the TTS system. This has the drawback however, that the video image of the character includes the microphone, laringagraph and other unwanted artefacts. More practical is the inclusion of a computer face animation module which uses only the motion capture elements of the video signal to animate a computer generated character which is programmed to look stylistically similar or identical to the subject character.

Animation

A further feature of certain embodiments involves providing a visual animation of a virtual or physical representation of the character selected for the audio voice. Preferably, a user could preferably design or by his agent cause to be designed a graphical simulation of said designed character. In toy-based embodiments, a user could produce or by his agent cause to be produced, accessories for said toy for attachment thereto, said accessories being representative of said character. The gaphical simulation or accessorised toy can optionally perform the, animated motion as previously described.

Animated characters (for example Blaze can be used) to synchronise the voice or other sound effects with the movement of the avatar (movement of mouth or other body parts) so that a recipient or user experiences a combined and synchronised image and sound effect.

In the toy embodiment, the toy may optionally have electromechanical mechanisms for performing animation of moving parts of the toy during the replay of recorded messages. The toy has a number of mechanically actuated lugs for the connection of accessories. Optionally, the accessories represent stylised body parts, such as eyes, hat, mouth, ears etc. or stylised personal acessories, such as musical instruments, glasses, handbags etc.

The accessories can be designed in a way that the arrangement of all of the accessories upon the said lugs of the toy's body provides a visual representation of the toy as a whole of a specific character or pesonality (for example, Elvis Presley). Peferably, the lugs to which accessories are attached perform reciprocation or other more complex motions during playback of the recorded message. This motion can be synchronised with the tempo of the spoken words of the message.

Optionally, the accesories may themelves be comprised of mechanical assemblies such that the reciprocation or other motion of the lugs of the toy cause the actuation of more comlex motions within the accessory itself. For example, an arm holding a teapot accessory may be designed with an internal mechanism of gears, levers and other mechanisms such that upon reciprocation of its connecting lug, the hand moves up, then out whilst rotating the teapot then retracts straight back to its rest position. Another example is an accessory which has a periscope comprising gears, levers and a concertina lever mechanism that upon reciprocation of its connecting lug, causes the periscope to extend markedly upwards, rotate 90 degrees, rotate back, then retract to its rest position. Vaious other arrangements are of course possible.

In embodiments, two or three dimensional computer graphic representations of the chosen characters may optionally be animated in time with the spoken audio format message in a manner which provides the impression that the animated character is speaking the audio format message. More complex animation sequences can also be provided.

In toy embodiments, the lug or lugs which relate to the mouth accessory are actuated so that the mouth is opened near the beginning of each spoken word and closed near the end of each spoken word, thus providing the impression that the toy is actually speaking the audio format message.

The other lugs on the toy can be actuated in some predefined sequence or pseudo-random sequence relative to the motion of the mouth, this actuation being performed by way of levers, gears and other mechanical mechanisms. A further feature allows for a more elaborate electromechanical design whereby a plurality of electromechanical actuators are located around the toy's mouth and eyes region, said actuators being independently controlled to allow the toy to form complex facial expressions during the replay of an audio format message.

A second channel of a stereo audio input cable connecting the toy to the computer can be used to synchronously record the audio format message and the sequence of facial and other motions that relate to the audio format message.

Toy embodiment specific aspects

Shown in FIG. 12 is a toy 70 that may be connectable to a computing means 72 via a connection means 74 through link 76 that may be wireless and therefore connected to a network or by fixed cable. The toy 70 has a non volatile memory 71 and a controller means 75. An audio message may be downloaded though various software to the computing means 72 via the Internet for example and subsequently transferred to the toy through the connection means 74.

A number of features specific to toy-based embodiments are now described. In one feature the audio format message remains in non-volatile memory 71 within the toy 70 and can be replayed many times until the user instructs the microprocessor in the toy, by way of the controller means 75, to erase the message from the toy. Preferably, the toy is capable of storing multiple audio format messages and replayig any of these messages by operation of the controller means 75. Optionally, the toy may automatically removes old messages from the non-volatile memory 71 when there is insufficient space to record an incoming message.

A further feature provides that when an audio format message is transmitted from the software to the user's computer processor means 72 and subsequently tansferred to the toy 70 by way of the connecting means 74, the message may optionally be encrypted by the software and then decrypted by the toy 70 to prevent users from listening to the message prior to replay of the message on the toy 70. This encryption can be peformed by reversing the time sequence of the audio format message with decryption being performed by reversing the order of the stored audio format message in the toy. Of course, any other suitable form of encryption may be used.

Another features provides that when an audio format message is transmitted from the software to the computing processor 72 and subsequently transferred to the toy 70 by way of the connecting means 74, the message may optionally be compressed by the software and then decompressed by the toy 70, whether the audio format message is encrypted or not. The reason for this compression is to speed up the recording process of the toy 70. In a preferred embodiment, this compression is preferably performed by sampling the audio format message at an increased rate when transferring the audio format message to the toy 70, thus reducing the transfer time. The toy subsequently, preferably interpolates between samples to recreate an approximation of the original audio format message. Other forms of analog audio compression can be used as appropriate.

In another feature, the toy 70 is optionally fitted with a motion sensor to detect motion of people within the toy's proximity and the software resident in the toy is adapted to replay one or a plurality of stored audio format messages upon detection of motion in the vicinity of the toy. Preferably, the user can operate the controller means 75 on the toy to select which stored message or sequence of stored messages will be replayed upon the detection of motion. Alternatively, the user may use the controller means 75 to organise the toy to replay a random message from a selection of stored messages upon each detection of motion or at fixed or random periods of time following the first detection of motion, for a period of time. The user may optionally choose from a selection of “wise-cracks” or other audio format messages stored on the Internet server computers for use with the toy's motion sensing feature. An example wise-crack would be “Hey you, get over here. Did you ask to enter my room?”

A further feature allows two toys to communicate directly with each other without the aid of a compatible computer or Internet connection. A first toy is provided with a headphone socket to enable a second toy to be connected to the first toy by plugging the audio input cable of the second toy into the headphone socket of the first toy. The user of the second toy then preferably selects and plays an audio format message stored in the second toy by operating the controlling means on the second toy. The first toy then detects the incoming audio format message from the second toy and records said message in a manner similar to as if said message had been transmitted by a compatible computer. This allows toy users to exchange audio format messages without requiring the use of connecting compatible computers.

Gift giving process

A further feature relates to a novel way of purchasing a toy product online (such as over the Internet) as a gift. The product is selected, the shipping address is entered, the billing addres and payment details and a peronalised greeting message is entered in a manner similar to regular online purchases. Thereafter, upon shipping of the product to the recipient of the gift, instead of printing the giver's personal greeting message (for example, “Happy birthday Richard, I thought this Elma Fudd character would appeal to your sense of humour. From Peter”) upon a card or gift certificate to accompany the gift, said greeting message is preferably stored in a database on the Internet server computer(s).

The recipient receives a card with the shipment of the toy product, containing instructions on how to use the Web to receive his personalised greeting message. The recipient then preferably connects his toy product to a compatible computer using the toy product's connecting means and enters the Uniform Resource Locator (URL) printed on said card into his browser on his compatible computer. This results in the automatic download and transfer to the recipient's toy product of an audio format message representing the giver's personl greeting message, spoken in the voice of the character represented by the stylistic design of the received toy product.

The recipient can operate controlling means on the toy product to replay said audio format message.

Multiple users

While the embodiments described herein are generally in relation to one or two users, they can be of course be readily extended to encompass any number of users which are able to interact with tbe Web site, the Web software, character TTS, character TTS, TVS, and in the toy embodiment, multiple toys as appropriate.

Also, multiple toy styles or virtual computer graphic characters may be produced, whereby each style is visually representative of a different character. Example characters include real persons alive or deceased, or characterisations of real persons (for example, television characters), cartoon or comic characters, computer animated characters, fictitious characters or any other form of character that has audible voice. Further, the stylisation of a toy can be achieved by modification of form, shape, colour and/or texture of the body of the toy. Interchangeable kits of clip-on body parts to be added to the toy's lugs or other fixed connection points on the body of the toy.

A further feature allows users of a toy embodiment to upgrade the toy to represent a new character without the need to purchase physical parts (for example, accessories) for fixation to the toy. The body of the toy and its accessories thereof are designed with regions adapted to receive printed labels wherein said labels are printed in such a manner as to be representative of the appearance of a specific character and said character's accessories. The labels are preferably replaceable, wherein new labels for say, a new character, can preferably be virtually downloaded via the Internet or otherwise obtained. The labels are visually representative of the new character. The labels are subsequently converted from virtual form to physical form by printing the labels on a computer printer attached to or otherwise accessible from said user's compatible computer.

Many voices

In any of the example applications, typically the use of one voice is described. However, the same principles can be applied to cover more than one voice speaking the same text at one time, and two or more voices speaking different character voices at the one time.

It will be understood that the invention disclosed and defined in this specification extends to all alternative combinations of two or more of the individual features mentioned or evident from the text or drawings. All of these different combinations constitute various alternative aspects of the invention.

1. A method of generating an audio message, comprising the steps of:
providing a text-based message; and
generating said audio message based on said text-based message;
wherein said audio message is at least partly in a voice which is representative of a character generally recognisable to a user.

2. A method according to claim 1 wherein said character is selected from a predefined list of characters, each character in said list being generally recognisable to a user.

3. A method according to either claim 1 or claim 2 wherein said generating step uses a textual or encoded database which indexes speech units with corresponding audio recordings representing said speech units.

4. A method according to either claim 1 or claim 2 wherein said generating step comprises concatenating together one or more audio recordings of speech units, the sequence of the concatenated audio recordings being determined with reference to indexed speech units associated with one or more of the audio recordings in said sequence.

5. A method according to claim 3 further comprising the step of substituting words in said text-based message that do not have corresponding audio recordings of suitable speech units with substitute words that do have corresponding audio recordings.

6. A method according to claim 3, wherein said speech units represent any one or more of the following: words, phones, sub-phones, multi-phone segments of speech.

7. A method according to claim 3 wherein said speech units cover the phonetic and prosodic range required to generate said audio message.

8. A method according to claim 5 wherein the substituted words are replaced with support words that each have suitable associated audio recordings.

9. A method according to claim 1 wherein after the step of providing said text-based message the method further comprising the step of converting said text-based message into a corresponding text-based message which is used as the basis for generating said audio message.

10. A method according to claim 9 wherein said step of converting said text-based message to a corresponding text-based message includes substituting said original text-base message with a corresponding text-based message which is an idiomatic representation of said original text-based message.

11. A method according to claim 10 wherein said corresponding text-based message is in an idiom which is attributable to, associated with or at least compatible with said character.

12. A method according to claim 10 wherein said corresponding text-based message is in an idiom which is intentinally incompatible with said character or attributable to or associated with a different which is generally recognisable by a user.

13. A method according to claim 1 wherein said audio message is generated in multiple voices, each voice representative of a different character which is generally recognisable to a user.

14. A method according to claim 1 wherein after the step of providing said text-based message the method further comprising the step of converting only a portion of said text-based message into a corresponding text-based message which is an idiomatic representation of the original text-based message.

15. A method according to claim 1 wherein said generating step includes randomly inserting particular vocal expressions or sound effects between certain predetermined audio recordings from which the audio message is composed.

16. A method according claim 1 wherein said text-based message is generated from an initial audio message from said user using voice recognition and subsequently used as the basis for generating said message in a voice representative of a generally recognisable character.

17. A method according to claim 1 further comprising the step of said user applying one or more audio effects to said audio message.

18. A method according to claim 17 wherein said one or more audio effects includes background sound effects to give the impression that the voice of the character emanates from a particular environment.

19. A method for generating an audio message which is at least partly in a voice representative of a character generally recognisable to a user, said method comprising the following steps:
transmitting a message request over a communications network;
processing said message request and constructing said audio message in at least partly a voice representative of a character generally recognisable to a user; and
forwarding the constructed audio message over said communication network to one or more recipients.

20. A computer program comprising computer program code to control a processing means to execute a procedure for generating an audio message according to the method of claim 1.
